(19) United States
(12) Patent Application Publication
(10) Pub. No.: US 2026/0099705 A1
(43) Pub. Date: Apr. 9, 2026

(54) UNLEARNING TEXT DATA FROM TRAINED LARGE LANGUAGE MODELS

(71) Applicant: Hirundo LTD, Tel Aviv (IL)

(72) Inventors: Tomer RAVIV, Ramat Gan (IL); Oded SHMUELI, Nofit (IL)

(73) Assignee: Hirundo LTD, Tel Aviv (IL)

(21) Appl. No.: 19/278,971

(22) Filed: Jul. 24, 2025

Related U.S. Application Data
(63) Continuation-in-part of application No. 19/171,381, filed on Apr. 7, 2025.
(63) Continuation-in-part of application No. 18/792,679, filed on Aug. 2, 2024.
(60) Provisional application No. 63/532,404, filed on Aug. 13, 2023.
(60) Provisional application No. 63/734,790, filed on Dec. 17, 2024.
(60) Provisional application No. 63/750,818, filed on Jan. 29, 2025.

(51) Int. Cl. G06N 3/08

(52) U.S. Cl. CPC G06N 3/08

(57) ABSTRACT

There is provided a computer implemented method of unlearning text data from a trained large language model (LLM), comprising: accessing a trained LLM trained on a training dataset of text data, selecting a first set of text data for being retained and a second set of text data for being unlearned, computing a domain separation for the trained LLM to disentangle the representations of the first set of text data and the second text within a latent representation space of the trained LLM by adapting weights of a set of neurons of the trained LLM, and generating an adapted LLM from the trained LLM, the adapted LLM comprising the trained LLM with the adapted weights in response to the domain separation.

### RELATED APPLICATIONS

This application claims the benefit of priority under 35 USC § 119(e) of U.S. Provisional Patent Application No. 63/734,790 filed on Dec. 17, 2024.

This application is also a Continuation-in-Part (CIP) of U.S. patent application Ser. No. 19/171,381 filed on Apr. 7, 2025, which claims the benefit of priority under 35 USC § 119(e) of U.S. Provisional Patent Application No. 63/750,818 filed on Jan. 29, 2025.

This application is also a Continuation-in-Part (CIP) of U.S. patent application Ser. No. 18/792,679 filed on Aug. 2, 2024, which claims the benefit of priority under 35 USC § 119(e) of U.S. Provisional Patent Application No. 63/532,404 filed on Aug. 13, 2023.

The contents of the above applications are all incorporated by reference as if fully set forth herein in their entirety.

### BACKGROUND

The present invention, in some embodiments thereof, relates to large language models (LLMs) and, more specifically, but not exclusively, to systems and methods for unlearning text data from trained LLMs.

Unlearning in a neural network involves removing the influence of specific training data without retraining the entire model from scratch. By adjusting the model's parameters or reweighting the training examples, the impact of the targeted data is minimized. This ensures the model forgets unwanted information while retaining overall performance.

### SUMMARY

According to a first aspect, system for unlearning text data from a trained large language model (LLM), comprises: a data storage device configured for storing data including a trained LLM trained on a training dataset of text data stored on a data storage device, wherein the LLM is implemented as a neural network with a plurality of weights defined for a plurality of connected neurons, a data interface configured for accessing the trained LLM, at least one processor operatively coupled to the data interface and to at least one memory, and configured for executing a code for: receiving a selection out of a first set of text data for being retained and a second set of text data for being unlearned, accessing memory locations of a memory storing weights of a set of neurons' connections of the trained LLM for adapting the stored weights for performing a domain separation on the trained LLM to disentangle the representations of a selected sub-set out of the first set of text data and the second set of text data, within a latent representation space of the trained LLM by, storing in the data storage device, an adapted LLM generated from the trained LLM, the adapted LLM comprising the trained LLM with the adapted weights in response to the domain separation, and accessing locations of the data storage device storing weights of the adapted LLM for adapting the stored weights for performing an unlearning process on the adapted LLM for unlearning of the second set of text data while maintaining inference performance on the first set of text data.

According to a second aspect, computer implemented method of unlearning text data from a trained large language model (LLM), comprises: accessing a trained LLM trained on a training dataset of text data, selecting a first set of text data for being retained and a second set of text data for being unlearned, computing a domain separation for the trained LLM to disentangle the representations of the first set of text data and the second text within a latent representation space of the trained LLM by adapting weights of a set of neurons of the trained LLM, and generating an adapted LLM from the trained LLM, the adapted LLM comprising the trained LLM with the adapted weights in response to the domain separation.

According to a third aspect, method of unlearning text data from a trained large language model (LLM), comprises: using at least one processor executing a code for: receiving a trained LLM trained on a training dataset of text data stored on a data storage device, wherein the LLM is implemented as a neural network with a plurality of weights defined for a plurality of connected neurons, receiving a selection out of a first set of text data for being retained and a second set of text data for being unlearned, accessing memory locations of a memory storing weights of a set of neurons' connections of the trained LLM for adapting the stored weights for performing a domain separation on the trained LLM to disentangle the representations of a selected sub-set out of the first set of text data and the second set of text data, within a latent representation space of the trained LLM by, storing in the data storage device, an adapted LLM generated from the trained LLM, the adapted LLM comprising the trained LLM with the adapted weights in response to the domain separation, and accessing locations of the data storage device storing weights of the adapted LLM for adapting the stored weights for performing an unlearning process on the adapted LLM for unlearning of the second set of text data while maintaining inference performance on the first set of text data.

In a further implementation form of the first, second, and third aspects, the unlearning process is performed on the adapted LLM for unlearning of the second set of text data by fine-tuning the adapted LLM on the second set of text data for being unlearned and on a subset of the first set of text data for being retained.

In a further implementation form of the first, second, and third aspects, the fine-tuning of the adapted LLM for unlearning is performed on said subset and first set employing a first loss function to produce a modified adapted model.

In a further implementation form of the first, second, and third aspects, a first component of the first loss function is designed to encourage the adapted LLM to forget the second set and to retain the first set, and a second component is designed for retaining the performance level of the LLM prior to the unlearning.

In a further implementation form of the first, second, and third aspects, further comprising code for iterating the computing of the domain separation, the generating the adapted LLM, the processing the adapted LLM for unlearning including the fine turning, and dynamically adapting hyperparameters during the iterations for optimizing a trade-off between the unlearning and retraining the first set.

In a further implementation form of the first, second, and third aspects, further comprising code for: freezing weights of the trained LLM, adding a low-rank adaptation (LoRa) layer to the trained LLM, wherein the domain separation is computed by adapting weights of the LoRa layer while maintaining unchanged the frozen weights of the trained LLM.

In a further implementation form of the first, second, and third aspects, selecting out of the first set of text data for being retained comprises: applying a text embedding process to the text data for embedding the text data into a latent representation space, computing similarity scores for each element of the first set indicating similarity with elements of the second set, and selecting a sub-set of the first set having similarity scores below a threshold or meeting a requirement indicating low similarity with the second set, wherein the domain separation is performed on the sub-set of the first set and the second set.

In a further implementation form of the first, second, and third aspects, further comprising: computing a cumulative similarity score for each element of the first set by aggregating the similarity scores over all elements of the second set, wherein the sub-set of the first set is selected as having cumulative similarity scores below the threshold of meeting the requirement, wherein the sub-set of the first set is selected using an iterative approach or a greedy approach by selecting a top number of the first set with highest cumulative similarity scores.

In a further implementation form of the first, second, and third aspects, each element of the first set and each element of the second set is represented as a vector within a latent representation space, and the domain separation is performed by at least one of: penalizing alignment of directions between a first vector of the first set and a second vector of the second set, minimizing magnitude of a dot product between the first vector and the second vector, training a binary-head classifier with a domain separation objective or adversarial domain loss to predict whether each vector belongs to a first class for being retained or a second class for being unlearned.

In a further implementation form of the first, second, and third aspects, the domain separation is performed by optimizing an objective function including a first component indicating amount of domain separation between the first set and the second set and a second component indicating retained performance of the LLM undergoing the domain separation during inference.

In a further implementation form of the first, second, and third aspects, further comprising code for: during training of the LLM on the training dataset including the first set of data for being retained and the second set of data for being unlearned, recording a plurality of recordings in a recording dataset, wherein a recording includes weight values of the LLM at the time at which the recording is recorded, computing a total-loss value of a change in a second loss function for each of plurality of training examples induced by a change of weights of the LLM in response to the second set of text data for being unlearned, determining a certain recording in the plurality of recordings to use to remove the second set of text data according to the total-loss values, and fine-tuning the adapted LLM the determined certain recording using the first set of text data and excluding the second set of text data, and providing an unlearned LLM comprising the fine-tuned adapted LLM.

In a further implementation form of the first, second, and third aspects, the second loss function includes a first component indicating weight changes from the second set of text data for being unlearned and a second component indicating weight changes from the full training dataset.

In a further implementation form of the first, second, and third aspects, a number of the recordings in the plurality of recordings is two, including a first recording at a start of the training of the LLM, and a second recording prior to end of the training of the LLM.

In a further implementation form of the first, second, and third aspects, the first set of text data includes data that excludes or has reduced undesired tendencies, wherein the second set of text data includes data indicating undesired tendencies, and further comprising performing the unlearning process for performing bias unlearning on the adapted LLM by fine-tuning the adapted LLM on text data that excludes or has reduced undesired tendencies to generate a reduced undesired tendencies LLM.

In a further implementation form of the first, second, and third aspects, further comprising code for: computing a first vector as a difference between weights of the reduced undesired tendencies LLM and weights of the adapted LLM prior to performing the fine-tuning of the adapted LLM, extracting a portion of the first vector that is less than or equal to a complete form of the first vector, adding the portion of the first vector to the adapted LLM prior to the fine-tuning for generating an updated adapted LLM designed to generate reduced undesired tendencies in responses, and providing the updated adapted LLM for generating reduced undesired tendencies in responses.

In a further implementation form of the first, second, and third aspects, the adapted LLM is fine-tuned to generate the reduced undesired tendencies LLM on ambiguous records, unambiguous records, and neutral utility records, wherein the adapted LLM is further fine-tuned using a third objective function including a first loss component designed to align predictions by the LLM with prompts exhibiting unknowns by minimizing cross-entropy loss over the ambiguous records according to a target corresponding to an unknown answer, a second loss component designed to retain performance over the unambiguous records, and a third loss component designed to preserve utility on neutral utility questions.

In a further implementation form of the first, second, and third aspects, ambiguous records and unambiguous records include examples of question-answering pairs, wherein ambiguous records labeled with socially stereotyped answers are used to generate biased representations, wherein unambiguous and/or neutral records are used to generate unbiased representations.

In a further implementation form of the first, second, and third aspects, the domain separation is applied between the first set including unambiguous context question with a corresponding correct answer, and the second set includes each of the ambiguous context questions with a corresponding incorrect stereotyped answer.

In a further implementation form of the first, second, and third aspects, further comprising: wherein the LLM is implemented as a neural network arranged in a plurality of layers including a plurality of neurons, for at least one layer of the plurality of layers, identifying a subset of a plurality of neuron activations correlated with captured latent undesired tendencies, generating a respective undesired tendencies subspace matrix for each respective layer from the corresponding subset of the plurality of neuron activations of the respective layer, and during inference of a new input prompt by the adapted LLM, sequentially applying the respective undesired tendencies subspace matrix to the corresponding neural activations of the respective layer, for obtaining a response by the adapted LLM with reduced undesired tendencies.

In a further implementation form of the first, second, and third aspects, the trained LLM comprises a baseline pre-trained LLM that is further fine-turned on a fine-tuning training dataset, wherein the first set of text data for being retained and a second set of text data for being unlearned are selected from the fine-tuning training dataset.

In a further implementation form of the first, second, and third aspects, further comprising: wherein the unlearning process is performed on the adapted LLM for unlearning of the second set of text data by fine-tuning employing a loss function on the adapted LLM over the second set of text data for being unlearned and over a subset of the first set of text data for being retained, wherein said loss function enhances retainment of the training of the trained LLM over text data from the subset in the adapted LLM, enhances not retaining the training of the trained LLM over the text data of the second set and optionally attempt at preserving the output distribution of the LLM.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for unlearning a LLM by domain separation and/or implementing other features, in accordance with some embodiments of the present invention; and

FIG. 2 is a flowchart of a method of unlearning a LLM by domain separation and/or implementing other features, in accordance with some embodiments of the present invention.

### DETAILED DESCRIPTION

The present invention, in some embodiments thereof, relates to large language models (LLMs) and, more specifically, but not exclusively, to systems and methods for unlearning text data from trained LLMs.

As used herein, the term large language model (LLM) is used as an exemplary and not necessarily limiting implementation of a model trained on text data to which domain separation is being applied. Other neural network implementations of the model may be substituted for the LLM, and/or other terms used in the art referring to a neural network mode trained on text data may be substituted for the LLM. As used herein, the term model and LLM are sometimes used interchangeably.

An aspect of some embodiments of the present invention relates to systems, methods, computing devices, and/or code instructions (stored on a data storage device and executable by one or processors) for pre-processing a trained LLM for unlearning text data by applying a domain separation to the trained LLM. The trained LLM has been trained on a training dataset of text data. A first set of text data for being retained is selected. A second set of text data for being unlearned is selected. The first set and the second set may be selected from the training dataset of text data used to train the trained LLM and/or used to fine-tune the pre-trained LLM. A domain separation is performed on the trained LLM. The domain separation is designed to disentangle the representations of the first set of text data and the second text within a latent representation space of the trained LLM by adapting weights of a set of neurons of the trained LLM. An adapted LLM is generated from the trained LLM. The adapted LLM is implemented as the trained LLM after undergoing domain separation, i.e., the trained LLM with the adapted weights generated in response to the domain separation. In the training associated with domain separation, the objective function (also referred to herein as loss function, or first loss function) may include a first component indicating amount of domain separation between the first dataset and the second dataset and a second component indicating retained performance of the LLM undergoing the domain separation during inference. The adapted LLM, i.e., the LLM after undergoing domain separation, may be provided for undergoing an unlearning process. The unlearning process may be implemented after the domain separation process, by fine-tuning the adapted LLM on the first set, optionally a subset selected from the first set, according to an objective function (optionally the first objective function). The fine-tuning may be performed on the second set, optionally a subset selected from the second set. The fine-tuning may be performed on the union of both sets, optionally a subset selected from the union of both sets. The loss function may enhances retainment of the training of the trained LLM over text data from the subset in the modified adapted LLM, enhances not retaining the training of the trained LLM over the text data of the second set and optionally attempts at preserving the output distribution of the LLM.

At least one embodiment addresses the technical problem of improving the process of unlearning text data from a trained LLM. At least one embodiment improves the technology of LLM, by providing an approach for improving the process of unlearning text data from a trained LLM. At least one embodiment improves upon prior approaches of unlearning text data from a trained LLM, by providing a pre-processing step to the trained LLM. At least one embodiment described herein provides the practical application of generating an adapted trained LLM which is generated by applying a domain separation process to the trained LLM, which has improved inference performance after undergoing unlearning of text data, in comparison to the performance of the trained LLM (alone that did not undergo domain separation) after unlearning.

At least one embodiment provides a solution to the aforementioned technical problem, and/or improves the aforementioned technology, and/or improves upon the aforementioned prior approaches, and/or provides the aforementioned technical application, by pre-processing a trained LLM for unlearning text data by applying a domain separation to the trained LLM. The trained LLM has been trained on a training dataset of text data. A first set of text data for being retained is selected. A second set of text data for being unlearned is selected. The first set and the second set may be selected from the training dataset of text data used to train the trained LLM and/or used to fine-tune the pre-trained LLM. A domain separation is performed on the trained LLM. The domain separation is designed to disentangle the representations of the first set of text data and the second text within a latent representation space of the trained LLM by adapting weights of a set of neurons of the trained LLM. An adapted LLM is generated from the trained LLM. The adapted LLM is implemented as the trained LLM after undergoing domain separation, i.e., the trained LLM with the adapted weights generated in response to the domain separation. After undergoing domain separation, the adapted LLM may be fine-tuned on the first set according to an objective function. The objective function may include a first component indicating amount of domain separation between the first dataset and the second dataset and a second component indicating retained performance of the LLM undergoing the domain separation during inference.

The field of Natural Language Processing (NLP) focuses on enabling computers to analyze, interpret, and generate human language, automating or semi-automating a wide range of text-related tasks. Common examples include text summarization, machine translation, sentiment analysis, question answering, and text generation. For many years, achieving high accuracy in these tasks faced significant challenges due to the limitations of traditional statistical methods, which struggled to capture the nuanced and complex patterns inherent in unstructured, high-dimensional data.

The advent of the deep learning era marked a paradigm shift in NLP. With it came a suite of transformative models and techniques capable of learning rich latent representations of language. These models harnessed the power of neural networks to uncover patterns and relationships within massive textual corpora, revolutionizing the field. Among the most impactful innovations are Large Language Models (LLMs), which leverage deep architectures and pretraining strategies to achieve unprecedented performance across a multitude of NLP tasks. LLMs have demonstrated remarkable generalization capabilities, enabling them to understand context, generate coherent and contextually appropriate text, and even exhibit emergent reasoning behaviors, cementing their status as cornerstone technologies in modern NLP.

LLMs have become widely spread tools for individuals and organizations worldwide. For individual users, LLMs such as ChatGPT, Gemini and Perplexity serve as accessible sources of information, generating insightful and contextually relevant responses to queries. Beyond simple Q&A functionality, these models are increasingly utilized as advanced search engines, capable of providing detailed explanations, summarizations, and even recommendations tailored to user needs.

A prominent application of LLMs lies in their role as conversational agents. Many of these models are designed as chat-based systems, enabling users to engage in ongoing, dynamic interactions. Such chat models maintain context across multiple turns, offering coherent and natural responses that mimic human-like conversations. This ability to sustain dialogue has made them invaluable in domains like customer support, virtual tutoring, content creation, and personal productivity tools.

Despite their widespread use, the deployment of LLMs raises significant challenges in areas such as data privacy, regulatory compliance, and the need for maintaining up-to-date knowledge. Jurisdictions worldwide increasingly mandate the ability to delete or “forget” personal data upon request, as required by regulations like the General Data Protection Regulation (GDPR) and the California Consumer Privacy Act (CCPA). Additionally, some LLMs may inadvertently have been trained on samples that propagate harmful or dangerous behaviors, exposing users to unethical or unsafe outputs. Furthermore, the knowledge embedded in LLMs can become outdated due to temporal or contextual changes, such as seasonal product discounts or evolving world events. For instance, an LLM trained on pricing data during a sale period may provide inaccurate information once the sale ends. Addressing these challenges is particularly complex for LLMs due to their high dimensionality and the entanglement of learned information within their vast parameter spaces.

What has driven LLMs' success—being highly parameterized and capable of learning intricate relationships in data—now becomes their limitation when attempting to remove specific information. It is inherently unclear which parameters encode the data targeted for removal, making selective deletion a non-trivial task. A naive approach would involve retraining the entire model from scratch while omitting the undesired data. However, this method is computationally prohibitive, particularly for LLMs, which often require extensive computational resources and weeks of training on specialized hardware. The impracticality of this approach is magnified in scenarios involving multiple or frequent data removal requests, underscoring the need for efficient and scalable solutions.

To address these challenges, a new field known as machine unlearning has emerged. This field focuses on developing techniques to remove targeted information directly from a trained model without necessitating full retraining. Machine unlearning seeks to selectively erase specific knowledge while preserving the model's overall performance and utility, balancing the objectives of data privacy, computational efficiency, and ethical AI deployment. The model is required to maintain the integrity of knowledge unrelated to the deleted knowledge and its capabilities with respect to it.

Machine unlearning can often be divided into two types of methods: Exact unlearning and approximated unlearning.

Exact unlearning involves the complete and verifiable removal of specific data from a model, ensuring that no trace of the removed knowledge remains. These methods are typically implemented at a system level and prioritize security and compliance, making them ideal for sensitive applications requiring provable guarantees of data deletion.

One of the most notable frameworks for exact unlearning is the Sharding, Isolation, Slicing, and Aggregation (SISA) framework. The core idea of SISA is to divide the training dataset into multiple disjoint shards, with each shard being used to train an independent sub-model. This setup isolates the influence of each data point to the sub-model associated with its shard. When a data point needs to be unlearned, only the sub-models affected by that data point require retraining, leaving the others untouched. While SISA is scalable and flexible, it has several limitations that include (1) since each sub-model is trained on a smaller subset of the data, it may struggle to generalize effectively, especially for complex tasks requiring holistic patterns; and (2) the framework necessitates running and storing multiple sub-models, which can introduce significant computational and storage overhead. To address some of SISA's drawbacks, other frameworks such as ARCANE have been proposed. ARCANE enhances SISA by reorganizing data partitions to optimize the unlearning process. Instead of randomly and evenly partitioning data, ARCANE divides the dataset into class-based subsets and trains sub-models independently using a one-class classifier for each subset. This approach accelerates unlearning for supervised learning tasks and reduces the need for retraining across irrelevant sub-models. However, ARCANE is limited to supervised learning scenarios, and it assumes a single-label per sample (example) setting, making it unsuitable for tasks involving multi-label data or unsupervised learning.

In contrast to exact unlearning, approximate unlearning aims to minimize the influence, without promise of complete removal, of the data to be forgotten to an acceptable degree. This trade-off allows for a more efficient unlearning process by relaxing strict requirements, making it suitable for scenarios where computational cost, latency, or storage constraints are critical. Approximate unlearning leverages techniques such as gradient-based optimization and stochastic gradient descent (SGD), auxiliary loss functions and influence-based methods to unlearn data. In this disclosure, embodiments relate to approximate unlearning methods, as they offer a pragmatic balance between compliance and performance, particularly for large-scale LLMs where exact unlearning may be infeasible.

Moreover, one has to note another close-by methodology named model editing. An interesting relationship exists between machine unlearning and the enticing model editing field. Though they are similar in their shared goal of modifying a trained model post-hoc (i.e., after training) to address specific objectives, their focus, scope and methodologies differ significantly. Model editing focuses on altering a model's knowledge to correct, augment, or adapt it to specific facts or behaviors. This often involves introducing new information, fixing errors, or ensuring the model produces desired outputs for particular prompts. Model editing involves identifying specific components of a model that correspond to the targeted knowledge and directly modifying their weights to reflect the desired change. This process ensures that the new knowledge is incorporated while preserving unrelated information already encoded in the model.

In contrast, approximate machine unlearning employs a more gradual approach. Instead of directly modifying specific parameters, it uses iterative refinement across the entire model. This is typically achieved through stochastic gradient descent (SGD)-based methods, where the model is adjusted progressively to minimize the influence of the data to be forgotten while maintaining overall performance. The direct, targeted nature of model editing stands in stark contrast to the softer, incremental adjustments characteristic of approximate machine unlearning.

At least one embodiment relates to unlearning text data from LLMs, potentially offering a solution to the pressing challenges of compliance, safety, outdatedness and/or adaptability. By leveraging innovative targeted knowledge removal techniques, at least one embodiment is designed to help ensure that specified information is effectively forgotten while maintaining the integrity and functionality of the model. This approach aligns with emerging legal and ethical standards, providing a secure, efficient, and practical framework for deploying LLMs in sensitive and regulated environments.

The scenarios in which machine unlearning is applied vary widely, each presenting unique requirements and challenges. These scenarios not only determine the scope of unlearning but also influence the choice of methods to achieve it effectively. Common scenarios include:

Instance/Entity Removal—Instance removal focuses on erasing the influence of specific data samples from the model. This scenario is commonly driven by privacy or compliance requirements, such as adhering to laws like GDPR or responding to user requests for data deletion. Examples include forgetting a specific medical image, such as a tumor scan, to protect patient confidentiality, or removing identifiable personal data, such as the credit card number or social security number of an individual. If the data to remove belongs to a single entity or multiple ones, this is referred to as entity removal case.

Fact Removal—Fact removal in unlearning refers to the process of erasing specific factual knowledge encoded in a model without necessarily targeting individual instances or entities. A “fact” in this context represents a specific piece of information or relationship, often stored in the model as part of its general knowledge base. In contrast to instance or entity level knowledge, fact removal operates at the level of conceptual knowledge rather than individual data points. It seeks to erase semantic general relationships or pieces of knowledge rather than removing all occurrences of an instance in the training data.

Class Removal—Class removal targets the deletion of an entire class or domain of knowledge from the model. This is particularly relevant in supervised learning scenarios or when dealing with specific knowledge domains in LLMs. Examples include removing a label such as “cat” from an image classification model, or unlearning a concept like “poetry” in a language model to prevent the generation of text in that domain.

Task Removal—Task removal involves disabling the model's ability to perform one or more specific tasks while ensuring that its performance on other tasks remains unaffected. This scenario is increasingly relevant as models are often trained for multi-tasking. One example is to disable a language model's ability to generate creative poetry while retaining its text summarization capabilities.

Stream Removal—Stream removal addresses scenarios where unlearning requests arrive sequentially over time. These requests may involve any of the previously mentioned scenarios (instance, class, or task removal) and often require the system to handle them efficiently without the ability to retrain the model from scratch after each request. Such scenarios include, e.g., continuous updates to remove outdated or sensitive information from an LLM trained on dynamic datasets.

Each of these scenarios highlights the diverse applications of machine unlearning, ranging from granular instance-level deletions to broader class and task-level modifications, and even dynamic, sequential updates. The ability to address these scenarios effectively is critical for enabling ethical, compliant, and efficient machine learning systems, especially in environments where data privacy and adaptability are mandatory. At least one embodiment described herein is designed to fit each scenario.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

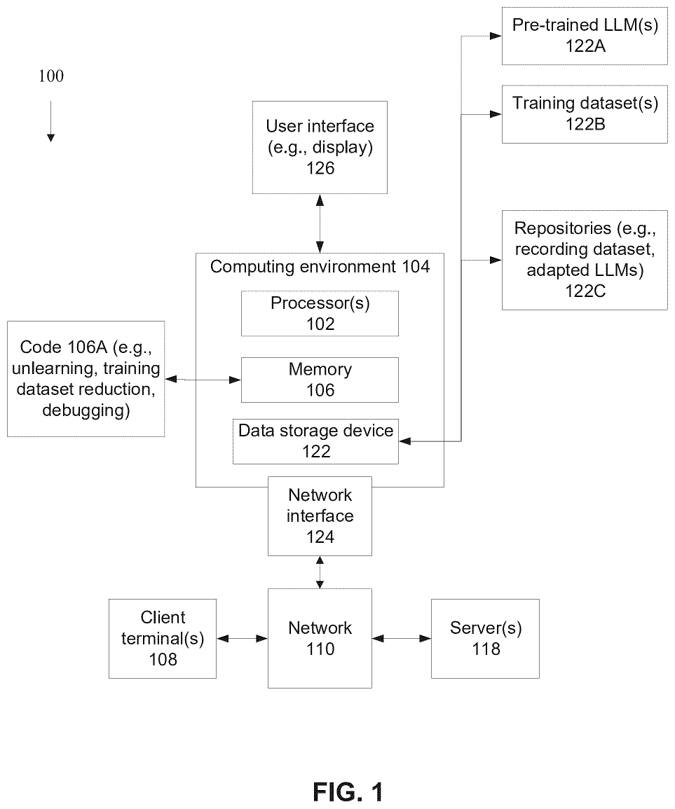

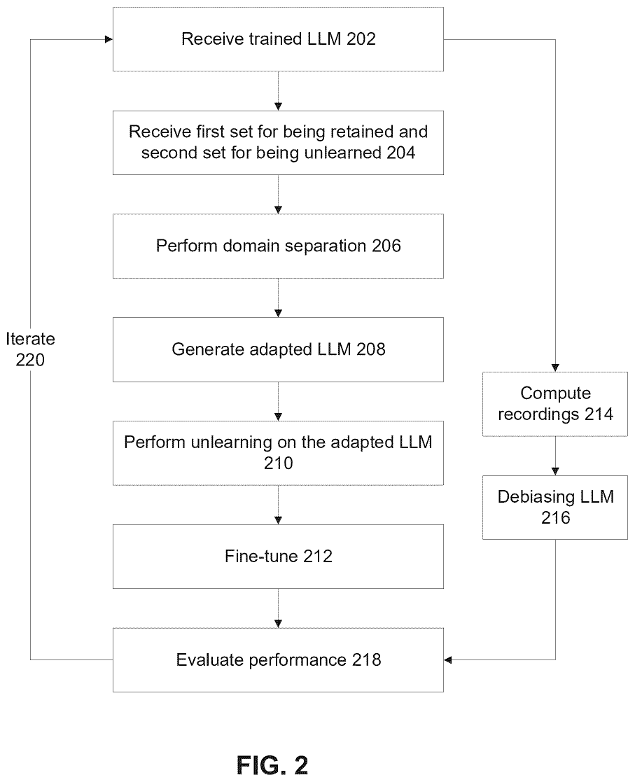

Reference is now made to FIG. 1, which is a block diagram of components of a system 100 for unlearning a LLM by domain separation and/or implementing other features, in accordance with some embodiments of the present invention. Reference is also made to FIG. 2, which is a flowchart of a method of unlearning a LLM by domain separation and/or implementing other features, in accordance with some embodiments of the present invention.

Referring now back to FIG. 1, system 100 may implement the acts of the method described with reference to FIG. 2, by processor(s) 102 of a computing environment 104 executing code instructions stored in a memory 106 (also referred to as a program store).

Computing environment 104 may perform domain separation of a trained LLM 122A and/or perform an unlearning process on the trained LLM which underwent domain separation, and/or other features described herein.

Computing environment 104 may be implemented as, for example one or more and/or combination of: a group of connected devices, a client terminal, a server, a virtual server, a computing cloud and/or other cloud platform such as a virtual private cloud (VPC), a virtual machine, a desktop computer, a thin client, a network node, and/or a mobile device (e.g., a Smartphone, a Tablet computer, a laptop computer, a wearable computer, glasses computer, and a watch computer).

Multiple architectures of system 100 based on computing environment 104 may be implemented. For example:

Computing environment 104 executing stored code instructions 106A, may be implemented as one or more servers (e.g., network server, web server, a computing cloud, a virtual server) that provides centralized services for performing domain separation on trained LLM 122A for performing an unlearning process of the trained LLM that underwent the domain separation. Services may be provided, for example, to one or more client terminals 108 over network 110, and/or to one or more server(s) 118 over network 110. Server(s) 118 may host one or more pre-trained LLMs 122A to undergo domain separation as a pre-processing step for unlearning. Services may be provided by computing environment 104 to client terminals 108 and/or server(s) 118, for example, as software as a service (SaaS), a software interface (e.g., application programming interface (API), software development kit (SDK)), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web site hosted by computing environment 104. In an example, pre-trained LLM 122A for which domain separation is to be performed may be hosted by computing environment 104. A user may use client terminal 108 to request domain separation of a certain pre-trained LLM 122A. In another example, pre-trained LLM 122A may be hosted by server(s) 118. Computing environment 104 may perform domain separation for pre-trained LLM 122A.

In another exemplary architecture, computing environment 104 may be implemented as a standalone device (e.g., server, client terminal, smartphone) that includes locally stored code instructions 106A that implement one or more of the acts described with reference to FIG. 2, for locally performing domain separation on pre-trained LLM 122A, and/or other features described herein. The locally stored code instructions 106A may be obtained from a server, for example, by downloading the code over the network, and/or loading the code from a portable storage device, such as by installing an app on a smartphone of a user.

Processor(s) 102 of computing environment 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIG. 2 when executed by hardware processor(s) 102.

Computing environment 104 may include a data storage device 122 for storing data, for example, pre-trained LLMs 122A for which domain separation is performed, training dataset(s) 122B of training examples for performing the domain separation on pre-trained LLMs 122A and/or one or more repositories 122C such as of a recording dataset set to store recordings (e.g., checkpoints), the adapted LLMs that are generated by applying the domain separation to the pre-trained LLMs, and the like. Data storage device 122 may be implemented as, for example, a memory, a local hard-drive, virtual storage, a removable storage unit, an optical disk, a storage device, and/or as a remote server and/or computing cloud (e.g., accessed using a network connection).

As used herein, the terms memory 106 and data storage device 122 may sometimes be interchanged. Use of one of the terms memory and data storage device is not meant to be necessarily limiting with respect to the location where code and/or data is stored. For example, data stored in data storage device 122 may be loaded into memory 106 for execution by processor 102. In another example, reference to data being stored in data storage device 122 may refer to the data being stored in memory 106.

Computing environment 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 110 may be implemented as, for example, the internet, a local area network, a virtual network, a wireless network, a cellular network, a local bus, a point to point link (e.g., wired or via BlueTooth), and/or combinations of the aforementioned.

Computing environment 104 and/or client terminal(s) 108 include and/or are in communication with one or more user interfaces 126 designed for a user to provide input and/or view output. Exemplary user interfaces 126 include, for example, one or more of, a touchscreen, a display, gesture activation devices, a keyboard, a mouse, and voice activated software using speakers and microphone.

Referring now back to FIG. 2, exemplary inputs to the method described with reference to FIG. 2 (e.g., for unlearning a model) include (1) a dataset of examples to forget D_{forget}, which is a subset of a textual corpus D; (2) a fine-tuned LLM M(y|x; θ₀) that was fine-tuned on D; (3) The pretrained model M(y|x; θ₋₁), prior to fine-tune on the dataset D is optional. A not necessarily limiting description of D, is described herein.

At 202, a trained LLM (also referred to herein as a pre-trained LLM) is received (e.g., accessed, generated, trained).

The trained LLM has been pre-trained on a training dataset of textual data. The LLM is implemented as a neural network with weights defined for multiple connected neurons.

The trained LLM may be stored on a data storage device, for example, a hard drive, a computing cloud, a virtual storage device, and the like, for example, as described herein.

The trained LLM may be accessed via a data interface, such as a network interface and/or virtual interface (e.g., API).

Exemplary mathematical representations are now described, which will be adhered to during the rest of the disclosure. The mathematical representations are not necessarily limiting, and are provided, for example, to help the reader understand embodiments described herein.

Let an LLM M be parameterized by the parameter vector θ. The model's output is a probability vector over the vocabulary of size V. The weights after the pretraining of the LLM may be denoted as θ₋₁. An entity (e.g., individual or a company) may further fine-tune the pretrained LLM, for example, to adapt it to each proprietary corpus data D. This fine-tuning yields initial values θ₀ after adaptation to the corpus D.

Training is commonly framed as the application of stochastic gradient descent (SGD) or its variants to optimize the objective function. The description below is directed towards defining the objective functions, rather than the specifics of their optimization. Any gradient-based iterative process can be employed to optimize these objectives effectively. The flexibility in optimization choice ensures that the embodiments described are broadly applicable and can adapt to different computational environments and constraints.

When an answer spans multiple tokens, the loss for each token position may be calculated against its preceding context, sum those token-level losses, and then include that total alongside the other components of the overall loss.

It is noted that any iterative optimization process uses training batches that are composed of both retain and forget samples. Their ratio can be chosen based on different strategies. Below, three different strategies are described as not necessarily limiting examples. One skilled in the art could readily adapt or choose alternative approaches to suit specific needs:
1. Mixed Batches with Equal Sampling: In this approach, each batch is constructed by sampling half of the examples from the retain dataset Dᵣₑₜₐᵢₙ and the other half from the forget dataset D_{forget}. This helps to ensure an equal representation of retain and forget samples in every batch, balancing their contributions to the unlearning process.
2. Weighted Sampling with Alpha Hyperparameter: This approach introduces a hyperparameter α (0≤α≤1) to control the proportion of retain and forget samples in a batch. For each batch, α×|batch size| samples are drawn from Dᵣₑₜₐᵢₙ, and (1−α)×|batch size| samples are drawn from D_{forget}. This strategy is designed to provide flexibility, allowing the user to prioritize one dataset over the other based on the unlearning objectives or the characteristics of the data. The value of a can be tuned to achieve the desired balance between forgetting and retaining knowledge. Note that the previous part is an instantiation of this one using α=0.5.
3. Randomized Sampling with Probability: In this approach, a probability P is assigned for selecting a sample from the retain dataset Dᵣₑₜₐᵢₙ, and 1−P for selecting a sample from the forget dataset D_{forget}. For each example in the batch, a random draw determines whether it is selected from Dᵣₑₜₐᵢₙ or D_{forget}. This method introduces stochasticity into the batch selection process, which can help mitigate bias and promote generalization during unlearning.

When training large language models (LLMs) using open-text question-answer formats, the input (denoted x) may include a prompt combining context and a specific question (e.g., “Context: She got off the flight from Peru to Iran. Question: Which place has people that were hateful toward women and children?”). The labels (y) in this format are open-ended textual answers, allowing the model to generate unrestricted natural language responses, such as “Iran”. This approach trains the model for generative flexibility, requiring it to understand and produce nuanced, contextually relevant responses without predefined constraints.

In contrast, the closed or multiple-choice QA format restricts answers to specific predetermined options. Here, the input (x) includes both context and question, followed explicitly by a structured set of labeled options (e.g., “Options: 1. Peru. 2. Iran.”). The labels (y) for training explicitly indicate the correct choice (e.g., “2” for “Iran”), thus converting the problem into a classification-like task. This structure simplifies the prediction task, facilitating more direct supervision, but limiting the model's generative freedom. The closed format often leads to clearer evaluation but might reduce the richness and diversity of the model's learned representations.

At 204, a first set of text data for being retained and a second set of text data for being unlearned (i.e., forgotten) are received (e.g., accessed) and/or selected. The selection may be performed automatically, for example, as described below.

The first set of text data and/or the second set of text data may be selected from the training dataset of text data used to fine-tune the trained LLM and/or to train the LLM (to generate the trained LLM). The trained LLM may be a generically trained LLM, which is subsequently fine-tuned on the training dataset of text data, for example, for specific application and/or specific domains. For example, the trained LLM is initially trained on text data from a wide variety of topics, and then fine-tuned on travel data to create a chatbot for automatic booking of vacations. The first and/or second datasets may be selected from data used to fine-tune the trained LLM, for example, to forget text data related to travel to regions with political unrest and/or high crime and to focus on travel to regions considered safe.

Additional exemplary details regarding the first and/or second datasets are now provided.

In terms of formal mathematical representation, two datasets may be defined (e.g., selected): the forget dataset (D_{forget}), also referred to herein as the second dataset, which includes the data to be removed from the model's knowledge, and the retain dataset (Dᵣₑₜₐᵢₙ), also referred to herein as the first dataset, which represents the knowledge that the model should retain, out of a textual corpus D. For chatbot LLMs and similar text-completion tasks, a text input is denoted by x, and y represents the corresponding output, e.g., an answer or text continuation in the form of a single token out of the vocabulary. It is noted that while the formulations described herein are designed for a single label token y loss calculation, the data may be extended by one skilled in the art to multiple tokens as explained in detail in the following sections (e.g., the formula for L_{dummy-forget}(y_{forget}|x_{forget}; θ)). When there are, for example, k tokens this gives rise to k examples, the i′^{th} one including of the original prompt and up to (i−1)′th token as prompt and the i′^{th} token as the answer.

In machine unlearning, the process typically begins by identifying a forget set D_{forget} (i.e., the second set) from a larger dataset of textual items D on which a model has been trained. A fundamental heuristic in machine unlearning is that effective forgetting is to be (optionally must be) balanced with retaining information that the model should continue to know. Focusing exclusively on forgetting can inadvertently degrade unrelated knowledge embedded within the model, leading to a loss of overall utility.

One approach in this scenario is to define the retain set Dᵣₑₜₐᵢₙ as the complement of the forget set within the original corpus, such that:

$${D}_{retain} = D / {D}_{forget} .$$

However, this disclosure proposes an alternative to the standard approach. Rather than using D/D_{forget} as the retain set by default, a subset of D/D_{forget} that is more effective for retaining the model's critical knowledge is selected. This targeted retain set is selected based on its relevance and utility in maintaining the model's performance on tasks unrelated to the forget set. The choice of a possibly proper subset of D/D_{forget} has the potential to retain the knowledge obtained from the whole D/D_{forget} during fine-tuning.

The training data is selectively curated to achieve specific learning objectives. Unlearning a forget dataset from a specific domain disproportionately affects collateral knowledge most related to the forget set. The retain set that facilitates the unlearning process and minimizes collateral damage to the model's broader knowledge base is selected.

Following the aforementioned guidelines, the selection of the retain set can be approached in different ways. The retain set choice can be guided by domain experts who manually select samples of similar nature, or domain, to those in the forget set. Alternatively, automated or semi-automated methods can be employed. Two approaches for retain choice selection are now described: (1) similarity-based retain set selection, and (2) influence-based retain set selection.

The first set of text data (for being retained), may be selected using the following exemplary approach. The selection is automatically performed by the processor. A text embedding process is applied to the text data for embedding the textual data into a latent representation space. Exemplary text embedding processes (e.g., functions) are described below. The latent representation space may be selected, for example, as any common latent space. Exemplary latent representations are described below. Similarity scores are computed between each element of the first set and each element of the second dataset. Each similarity score indicates an amount of similarity between the pair of elements, of a certain element of the first dataset and a certain element of the second dataset. Exemplary similarity functions to compute the similarity score are described below. A subset of the first set (to be retained) having similarity scores below a threshold or meeting a requirement indicating low similarity with the second set (to be unlearned), is selected. Alternatively, depending on the way that the similarity score is defined (i.e., whether a high similarity score represents a high similarity or a low similarity), the subset of the first set having similarity score above the threshold or meeting the requirement indicating low similarity with the second set, is selected. The selected subset represents elements that are sufficiently different from the elements of the second set, which are to be forgotten. The non-selected elements of the first set are substantially similar to the second set, representing additional elements, which may be forgotten. Optionally, a cumulative similarity score is computed for each element of the first set. The cumulative similarity score is computed for a certain element of the first set by aggregating the similarity scores over all pairs of the certain element of the first set and each element of the second set. The subset of the first set may be selected as having cumulative similarity scores below (or above depending on how the similarity score is defined) the threshold of meeting the requirement, where the subset of the first set represents elements sufficiently different from the elements of the second set. The subset of the first set may be selected, for example, using an iterative approach and/or a greedy approach by selecting a top number of the first set with highest cumulative similarity scores, for example, as detailed below. The domain separation is performed on the subset of the first set, for example, as described herein.

Additional exemplary detail for selecting the subset of the first set for performing domain separation are now provided:

### Similarity-Based Retain Set Selection:

Another approach to selecting the retain set involves embedding the forget and retain samples into a shared latent space and using these embeddings to compute similarity scores. This approach leverages the idea that data samples with similar latent representations (e.g., contextual embeddings) are likely to have related semantic content or functional impact. By measuring the similarity between embeddings of forget samples and retain samples, retain samples that either support effective forgetting or minimally interfere with it may be identified.

To begin, each sample x from the dataset is embedded into a latent vector u using a pretrained embedding function ƒ_{emb}:x→u. Examples of such embedding functions include:
1. Contextual embeddings from large language models (e.g., BERT, GPT).
2. Sentence embeddings (e.g., Sentence-BERT).
3. Task-specific embeddings from fine-tuned models. Including the output of M(y|x; θ₀) (the model fine-tuned on D), or intermediate hidden outputs of it.

Additional embedding functions are described herein; however, one skilled in the art may select alternative embedding functions as appropriate. Next, the score function S(u_{forget}, uₒₜₕₑᵣ)→ [symbol] , where [symbol] is the set of real numbers, is defined. This embedding function measures the relationship between the embedding of a forget sample u_{forget} and another sample uₒₜₕₑᵣ. Examples of score functions, to compute the similarity score, include:

$$Cosine Similarity \text{:} s ( {u}_{forget} , {u}_{other} ) = \frac{\vert {u}_{forget} \cdot {u}_{other} \vert}{‖ {u}_{forget} \vert \vert \cdot \vert \vert {u}_{other} ‖} .$$

$$Euclidean Distance \text{:} s ( {u}_{forget} , {u}_{other} ) = - ‖ {u}_{forget} - {u}_{other} ‖$$

Learned Metric: A trainable network can parameterize S(u_{forget}, uₒₜₕₑᵣ) to learn a task-specific relationship.

Here, ∥u∥ denotes the L2 norm of the vector u, and |a| is the absolute value of a scalar a.

For the chosen similarity metric, the retain samples may be selected based on the following steps:
Compute Similarity Scores—For each other sample (xₒₜₕₑᵣ,yₒₜₕₑᵣ) ϵD/D_{forget} compute its similarity score with every forget sample (x_{forget}, y_{forget}) ϵD_{forget} using the score function S(ƒ_{emb}(x_{forget}), ƒ_{emb}(xₒₜₕₑᵣ)).
Cumulative Score Calculation—Aggregate the scores over all forget samples to compute the cumulative similarity for each retain sample:

$${S}_{cum} ( {x}_{other} ) = {\sum }_{( {x}_{forget} , {y}_{forget} ) ∈ {D}_{forget}} s ( {f}_{emb} ( {x}_{forget} ) , {f}_{emb} ( {x}_{other} ) )$$

Rank Retain Samples—Rank the (xₒₜₕₑᵣ,yₒₜₕₑᵣ) ϵD/D_{forget} samples by their cumulative similarity scores S_{cum}(xₒₜₕₑᵣ). High cumulative similarity indicates that a retain sample is closely related to the forget samples and is likely to influence the forgetting process.
Select Retain Set—The selection of the final retain set, composed of k selected elements, could be done either in a greedy or iterative way. For example, under the greedy approach the top k retain samples with the highest cumulative similarity scores are selected to form the targeted retain set Dᵣₑₜₐᵢₙ:Dᵣₑₜₐᵢₙ={(xₒₜₕₑᵣ,yₒₜₕₑᵣ)|S_{cum}(xₒₜₕₑᵣ) is among the top k}.

The size of the retain set, k, can be determined using various approaches. For instance, k may be defined as a hyperparameter set by the user prior to the process, either as an absolute number of elements or as a percentage of the complement of the forget set within the original corpus (D/D_{forget}). Alternatively, k can be dynamically chosen based on the knee point of the cumulative distribution of the similarity scores S_{cum}(xₒₜₕₑᵣ) computed for all examples xₒₜₕₑᵣ ϵD/D_{forget}.

### Influence-Based Retain Set Selection

Another approach involves using influence functions. Over the past decade, influence functions have evolved to quantify how training on one sample impacts another in terms of loss or accuracy. This capability makes influence functions a useful tool for guiding retain set selection, as they can identify samples in the retain set that have the greatest positive or neutralizing impact on the forget set.

For example, refer to the influence function from the paper “Understanding black-box predictions via influence functions” by Koh and Liang, incorporated herein by reference in its entirety (though one skilled in the art may select alternative influence functions as appropriate for the specific application.). Their suggested influence function I_{up,loss}(z,zₜₑₛₜ) quantifies the change in the loss for a test point zₜₑₛₜ when a training point z is upweighted by an infinitesimal amount. It is computed as:

$${I}_{up , loss} ( z , {z}_{test} ) = - {∇}_{θ} {L ( {z}_{test} ; θ )}^{T} {H}^{- 1} {∇}_{θ} L ( z ; θ ) , \qquad ( ii )$$

Where ∇_{θ}L(z; θ) is the gradient of the loss with respect to the model parameters θ for the training point z, H is the Hessian matrix of second derivatives of the loss with respect to θ, and the operations (⋅)^{T} and (⋅)⁻¹ denote the transpose and inverse operators, respectively.

Using it, the most influential candidates on the samples of the forget set may be selected by employing the following exemplary process:
Compute Influence Scores—For each sample (xₒₜₕₑᵣ, yₒₜₕₑᵣ) ϵD/D_{forget}, compute its influence score using equation (ii) on a forget set sample (x_{forget}, y_{forget}) ϵD_{forget}:

$${I}_{score} ( {x}_{other} , {x}_{forget} ) = - {∇}_{θ} {{L}_{other} ( {y}_{other} \vert {x}_{other} ; θ )}^{T} {H}^{- 1} {∇}_{θ} {L}_{forget} ( {y}_{forget} \vert {x}_{forget} ; θ )$$

Where I_{score} (xₒₜₕₑᵣ, x_{forget}) quantifies the impact on the loss of sample (x_{forget}, y_{forget}) when training on (xₒₜₕₑᵣ, yₒₜₕₑᵣ).
Rank Retain Samples—Compute the cumulative influence of each candidate sample on all forget samples:

$${I}_{cum} ( {x}_{other} ) = {\sum }_{( {x}_{forget} , {y}_{forget} ) ∈ {D}_{forget}} {I}_{score} ( {x}_{other} , {x}_{forget} ) .$$

Now, each retain sample is associated with a cumulative influence score. Positive or near-zero scores indicate samples that help neutralize or minimally interfere with forgetting.
Select Retain Set—The selection of the final retain set, composed of k selected elements, could be done either in a greedy or iterative way. For example, under the greedy approach the top k retain samples with the highest cumulative similarity scores are selected to form the targeted retain set Dᵣₑₜₐᵢₙ:

$${D}_{retain} = \{ ( {x}_{other} , {y}_{other} ) \vert {I}_{cum} ( {x}_{other} ) is among the top k \}$$

The size of the retain set, k, can be determined using various approaches. For instance, k may be defined as a hyperparameter set by the user prior to the process, either as an absolute number of elements or as a percentage of the complement of the forget set within the original corpus (D/D_{forget}). Alternatively, k can be dynamically chosen based on the knee point of the cumulative distribution of the similarity scores I_{cum}(xₒₜₕₑᵣ) computed for all examples xₒₜₕₑᵣ ϵD/D_{forget}.

This process leverages influence functions to construct a targeted retain set, facilitating the unlearning process while balancing the trade-off between effective forgetting and preserving model performance.

In summary, retain set selection can be performed manually, leveraging expert knowledge, or automatically, guided by machine learning techniques such as embeddings or influence metrics. Regardless of the approach, the goal is to ensure that the retain set comprises samples that share a similar nature with the forget set, thereby optimizing the unlearning process while preserving the model's overall integrity.

Additional exemplary approaches for selecting the retain set, i.e., the first set, are provided:
Retain Set Choice—The retain set Dᵣₑₜₐᵢₙ is constructed from examples used during the LLM's fine-tuning on the corpus data D, depending on the scenario. It is understood that a person skilled in the art could select alternative methods, techniques, or parameters suited to the specific application or desired outcome, without departing from the spirit and scope of this invention. The scenarios include:
   1. Case 1: Dᵣₑₜₐᵢₙ is simply selected as D/D_{forget}.
   2. Case 2: Dᵣₑₜₐᵢₙ is curated by domain experts based on a manual selection process.
   3. Case 3: Dᵣₑₜₐᵢₙ is selected as the k examples from D/D_{forget} that have the maximal similarity score to the forget samples D_{forget}, as in Section III.B. Specifically:
      (1) Embed Dataset: Map each sample x to a latent vector u using a pretrained embedding function ƒ_{emb}: x→u (e.g., BERT, GPT, Sentence-BERT, or task-specific embeddings).
      (2) Define a Score Function: Use a similarity metric s: (u₁, u₂)→ [symbol] (e.g., cosine similarity, Euclidean distance, or a learned metric) to measure the relationship between embeddings of forget samples and other samples.
      (3) Compute Similarity Scores: For each sample (xₒₜₕₑᵣ,yₒₜₕₑᵣ) ϵD/D_{forget}, calculate its similarity score with every forget sample (x_{forget},y_{forget}) ϵD_{forget}.
      (4) Cumulative Score Calculation: Aggregate similarity scores across all forget samples to compute a cumulative similarity score for each retain candidate:

$${S}_{cum} ( {x}_{other} ) = {\sum }_{( {x}_{forget} , {y}_{forget} ) ∈ {D}_{forget}} s ( {f}_{emb} ( {x}_{forget} ) , {f}_{emb} ( {x}_{other} ) )$$

(5) Rank and Select Retain Samples: Rank the (xₒₜₕₑᵣ, yₒₜₕₑᵣ) ϵD/D_{forget} samples by their cumulative similarity scores S_{cum}(xₒₜₕₑᵣ).
(6) Rank and Select Retain Samples: Rank all candidates in (xₒₜₕₑᵣ,yₒₜₕₑᵣ) ϵD/D_{forget} by S_{cum}, and select the top k samples with the highest scores to form the retain set: Dᵣₑₜₐᵢₙ={(xₒₜₕₑᵣ,yₒₜₕₑᵣ)|S_{cum} is among the top k}.
4. Case 4: Dᵣₑₜₐᵢₙ is selected as the k examples from D/D_{forget} that have the maximal aggregated influence score with respect to the forget samples D_{forget}. The methodology is:
   (1) Define Influence Function: Use the influence function I_{score}(x_{forget},xᵣₑₜₐᵢₙ)=I_{up,loss}(z,zₜₑₛₜ), or any other influence function, to measure the impact of upweighting a sample (xₒₜₕₑᵣ, yₒₜₕₑᵣ) ϵD/D_{forget} on the loss/accuracy of a forget sample (x_{forget},y_{forget})ϵD_{forget}.
   (2) Compute Influence Scores: For each candidate (xₒₜₕₑᵣ,yₒₜₕₑᵣ) ϵD/D_{forget}, compute the influence score I_{score}(x_{forget}, xᵣₑₜₐᵢₙ) with every forget sample (x_{forget},y_{forget}) ϵD_{forget}.
   (3) Cumulative Influence Calculation: Aggregate the influence scores across all forget samples to compute the cumulative influence score for each candidate I_{cum}(xₒₜₕₑᵣ)=Σ₍ₓ_{ₒₜₕₑᵣ}_{,y}_{ₒₜₕₑᵣ}_{)ϵD/D}_{_{forget}}I_{score}(xₒₜₕₑᵣ, xₒₜₕₑᵣ).
   (4) Rank and Select Retain Samples: Rank all candidates by I_{cum}(xₒₜₕₑᵣ). Select the top k samples with the highest cumulative influence scores to form the retain set Dᵣₑₜₐᵢₙ={(xₒₜₕₑᵣ,yₒₜₕₑᵣ)|I_{cum} is among the top k}.

The output of this stage is the retain set Dᵣₑₜₐᵢₙ.

At 206, a domain separation (i.e., process) is performed on the trained LLM. The domain separation is performed to disentangle the representations of the first set of text data and the second set of text data, within a latent representation space of the trained LLM. The domain separation may be of the subset of the first set and the second set of data, where the subset of the first set was selected for example, as described above. The latent representation may be the latent representation used for selection of the subset, or another latent representation.

Optionally, locations of a memory storing weights of a set of neurons' connections of the trained LLM are accessed, for adapting the stored weights for performing the domain separation on the trained LLM.

The domain separation may be performed, for example, one or more approaches described herein.

Optionally, the domain separation is performed by freezing weights of the trained LLM, and adding a low-rank adaptation (LoRa) layer, or other implementations, to the trained LLM. The domain separation is computed by adapting weights of the LoRa layer while maintaining unchanged the frozen weights of the trained LLM. This domain separation process helps preserve the original weights of the trained LLM, while implementing the domain separation by the LoRA layer (or other implementation).

Alternatively or additionally, the domain separation may be done by representing each element of the first set and each element of the second set is as a vector within a latent representation space, optionally the latent representation space described herein. Exemplary approaches for mapping elements of the first and/or second dataset to the latent representation space are described herein. In one exemplary approach, the domain separation may be performed by penalizing alignment of directions between a first vector of the first set and a second vector of the second set. The penalty may computed between pairs of first vectors of the first set and second vectors of the second set. Alternatively or additionally, the penalty may be computed between an aggregation of first vectors of the first set and an aggregation of second vectors of the second set. The aggregation may be computed as, for example, an average, optionally weighted average, of the respective first vectors and second vectors. In another exemplary approach, the domain separation may be performed by minimizing magnitudes of a dot product between the first vector and the second vector. The minimization may be between pairs of first and second vectors, or between an aggregation of the first vector and an aggregation of the second vector. In yet another approach, a binary-head classifier is trained using a domain separation objective and/or adversarial domain loss to predict whether each vector (from the first set and the second set) belongs to a first class for being retained or a second class for being unlearned. The domain separation may be performed by optimizing an objective function including a first component indicating amount of domain separation between the first dataset and the second dataset and a second component indicating retained performance of the LLM undergoing the domain separation during inference.

A discussion of latent representation in NLP is now provided.

The evolution of latent representations in text processing has significantly advanced natural language understanding. Count-based methods, such as bag-of-words and term frequency-inverse document frequency (TF-IDF), were among the earliest approaches. These methods represent text by counting the frequency of each word in a given piece of text, resulting in high-dimensional vectors corresponding to the vocabulary size. While simple and easy to implement, these techniques have notable disadvantages. They fail to capture semantic similarities between words treating “happy” and “joyful” as entirely unrelated. Additionally, the vectors are often sparse due to large vocabulary sizes, leading to the curse of dimensionality, which can hinder machine learning algorithms by increasing computational complexity and the risk of overfitting.

To address these limitations, word embeddings like the ones output by tools such as Word2Vec and GloVe were introduced. These models aim to capture semantic meanings by learning dense, low-dimensional vectors for words based on their contexts within a large corpus. For example, Word2Vec uses neural networks to learn word associations, allowing it to recognize that “king” and “queen” are related. However, these embeddings assign the same vector to a word regardless of its context, failing to account for cases where a word has multiple meanings. They also do not inherently capture the meaning of entire sentences or phrases. To represent sentences, one might average or sum the word embeddings of individual words, but this simplistic approach often loses the nuances of word order and syntactic structures.

The introduction of large text models like Bidirectional Encoder Representations from Transformers (BERT) marked a significant advancement in capturing contextual information. BERT generates contextualized word embeddings, meaning the representation of a word varies depending on the surrounding words. This allows the model to distinguish between different meanings of the same word based on context—for instance, “bank” in “river bank” versus “financial bank”. BERT considers both left and right contexts in all layers, providing a deeper understanding of language nuances. Its ability to capture full-sentence embeddings has improved performance across various natural language processing tasks, such as question answering and sentiment analysis.

Building upon models like BERT, current language models such as GPT-3, GPT-4, and T5 have pushed the boundaries even further. These models utilize transformer architectures to handle long-range dependencies in text and are trained on massive datasets, enabling them to generate coherent and contextually relevant responses. The advantages of these models lie in their ability to understand and generate human-like text with a high degree of fluency and relevance. Their latent embeddings are the “richest” in terms of information one can employ for a given downstream task. However, they come with disadvantages, including substantial computational resource requirements for training and deployment.

These approaches effectively map a sample x to the corresponding latent embedding u. This family of approaches is denoted as ƒ_{emb}: x→u. For example:
1. Bag-of-Words Embedding: A (simple and) interpretable embedding approach that represents a sample x as a vector u of token frequencies (word or sub-word presence indicators). Mathematically, let x be a sequence of tokens {x₁, . . . x_{T}} from vocabulary V. The bag-of-words embedding is given as:

$${u}_{i} = {\sum }_{t = 1}^{T} 1 ( {x}_{t} = {v}_{i} ) , for i = 1 , 2 , … , V .$$

where vᵢ is the i-th token in the vocabulary, and 1(⋅) is the indicator function. The resulting vector u is of size V and captures the frequency or occurrence of tokens in x, ignoring their order.
2. BERT Embedding: A deep, contextualized embedding that captures semantic relationships between words in a sequence x of tokens. BERT computes an embedding u by processing x through a series of transformer layers:

$$u = BERT ( x )$$

Where the BERT embedding is described in “Bert: Pre-training of deep bidirectional transformers for language understanding” by Devlin et al.

Exemplary approaches for domain separation are now described.

Domain separation may involve fine-tuning an existing model to disentangle latent representations associated with two (or more) data distributions within the same network. The central idea is to enforce a form of representation independence or separation between the domains, ensuring that features learned from one distribution do not overlap with features learned from the other. Explicitly separating the representations of each domain within the model ensures that domain-specific features are captured independently. In classical models such as ResNet, this approach may entail augmenting the existing latent embedding mechanism by attaching a dedicated binary classification head. This binary head distinguishes whether each embedding belongs to the “forget” domain or the “retain” domain. By initially training this binary head and subsequently freezing its parameters, gradients can be effectively propagated back through the embedding layers. This enables the embedding network to better separate latent vectors belonging to forget examples from those representing retain examples, thus facilitating targeted and efficient unlearning of specific domain-associated information. The binary head is later removed from the model. This is one discriminative approach to facilitate separation; however, other contrastive methods can also serve the same purpose, see the next technical sections for full details.

In LLMs and other generative architectures, domain separation adopts a complementary but nuanced approach. In at least one embodiment, representations correspond to semantic or factual contexts of the generated content rather than explicit classification outputs. To apply domain separation for unlearning in these models, a similar logic is employed by guiding the internal hidden states toward domain-specific disentanglement. By employing a discriminative or contrastive auxiliary training objective, the model learns to internally distinguish between forget and retain contexts, with the examples provided subsequently. Consequently, features associated with the forget domain become isolated within the model's representational space. This facilitates selective weakening or removal of specific knowledge or biases without compromising overall model integrity, thereby achieving targeted unlearning in generative and language-based frameworks.

Training is commonly framed as the application of SGD or its variants to optimize the objective function. The description herein relates to defining the objective functions, rather than the specifics of their optimization. Any gradient-based iterative process can be employed to optimize these objectives effectively. The flexibility in optimization choice ensures that the methods described are broadly applicable and can adapt to different computational environments and constraints. Note that here, similar to the unlearning scenario described herein, forget and retain samples are combined in each batch. Their ratio can be chosen based on different strategies. Each of the strategies described herein can be chosen here, including (1) Mixed Batches with Equal Sampling; (2) Weighted Sampling with Alpha Hyperparameter; and (3) Randomized Sampling with Probability. However, one skilled in the art could pick other strategies as well.

Mathematically, the objective is to directly maximize some defined metric that intuitively represents the distance between the representations of examples from each distribution. Let D₁ and D₂ be two datasets, with samples x₁ϵD₁ and x₂ϵD₂. A shared learnable embedding ƒ_{φ}: x→u with weights d maps input sample x into latent representation u. The goal is to ensure that representations u₁=ƒ_{φ}(x₁) and u₂=ƒ_{φ}(x₂) are as dissimilar as possible, according to a chosen dissimilarity metric L_{dissimilarity}, while maintaining performance of ƒ_{φ} for downstream tasks.

Domain separation could be achieved by optimizing the embedding network ƒ_{φ} using either of the following exemplary losses:
Cosine Dissimilarity Loss—The cosine dissimilarity loss encourages separation by penalizing alignment in the directions of u₁ and u₂ (note that we strive at having the vectors point in different direction, i.e., as orthogonal as possible, as even pointing in the opposite direction introduces a correlation):

$${L}_{cosine} ( {u}_{1} , {u}_{2} ; {f}_{ϕ} ) = \frac{\vert {u}_{1} \cdot {u}_{2} \vert}{‖ {u}_{1} ‖ \cdot ‖ {u}_{2} ‖} .$$

Orthogonality Loss—Instead of focusing on directions, the orthogonality loss directly separates the representations by minimizing the magnitude of their dot product: L_{orthogonality}(u₁,u₂; ƒ_{φ})=|u₁·u₂|.
Adversarial Domain Loss—A classifier N, parameterized by φ, predicts whether a representation u belongs to D₁ (label 0) or D₂ (label 1). The adversarial loss is: L_{adv}(u₁; u₂; ƒ_{φ}; N_{φ})=−log(1−N_{φ,2}(u₁))−log(N_{φ,2}(u₂))

Here, N_{φ,2}(u) represents the probability predicted by the classifier N_{φ} that u belongs to D₂. The parameters of the embedding function ƒ_{φ} are trained to minimize this loss, with gradients being propagated through N_{φ}.
Downstream Task Loss—To help ensure the embedding network retains its utility for downstream tasks, a performance loss L_{downstream}(x; ƒ_{φ}) may be included, which measures task-specific objectives such as classification or regression.

The combined optimization objective balances separation and downstream performance is denoted as:

$$arg {min}_{{f}_{emb}} {λ}_{separation} {L}_{separation} ( {u}_{1} , {u}_{2} ; {f}_{ϕ} ) + {λ}_{downstream} {L}_{downstream} ( x ; {f}_{ϕ} ) \qquad ( iii )$$

Where the coefficients λₛₑₚₐᵣₐₜᵢₒₙ and λ_{downstream} allow for balancing the two objectives. Lₛₑₚₐᵣₐₜᵢₒₙ can be L_{cosine}, L_{orthogonality}, L_{adv} or any other dissimilarity-promoting loss. The λₛₑₚₐᵣₐₜᵢₒₙ and λ_{downstream} coefficients do not necessarily sum to 1.

In the context of machine unlearning, domain separation may address challenges arising from overlapping characteristics between the retain (Dᵣₑₜₐᵢₙ) and forget (D_{forget}) datasets. Overlap can lead to knowledge entanglement, where representations of forget samples are intertwined with those of retain samples. Direct unlearning in such cases may degrade performance on the retain set by inadvertently removing shared knowledge.

To mitigate this, at least one embodiment is based on incorporating a domain separation preprocessing stage. This step disentangles the latent representations of retain and forget datasets, reducing collateral damage to the retain set during unlearning.

The forget samples in the forget set are denoted as (x_{forget},y_{forget}) ϵD_{forget}, and the retain samples in the retain set are denoted as (xᵣₑₜₐᵢₙ,yᵣₑₜₐᵢₙ) ϵDᵣₑₜₐᵢₙ. Let ƒ′: x→u be a mapping function with parameters θ′ representing a subset of the full parameter vector θ of the LLM. For example, these mappings include various embedding extraction strategies that leverage different layers or combinations of layers within the model, each designed to capture specific characteristics of the input data:
1. Intermediate Layer Extraction: The mapping function ƒ′ can utilize the output of an intermediate layer of the model. For instance, selecting embeddings from the penultimate transformer block provides a balance between high-level semantic understanding and structural information of the input.
2. Last Layer Prior to Fully Connected Layer: The mapping function ƒ′ may extract the embeddings from the final layer immediately preceding the last fully connected layer. These embeddings are often optimized for the model's primary task and capture task-specific features that are highly relevant for domain separation.
3. Combination of Intermediate and Last Layers with Averaging: A hybrid approach can combine embeddings from multiple layers, such as the intermediate and last layers, by averaging their outputs. This approach integrates both general-purpose and task-specific features, creating a more robust representation for domain separation.

It is noted that one skilled in the art may select alternative embedding functions or methodologies as appropriate for the specific application.

No matter the exact choice of ƒ′, the goal is the same: To optimize θ′ using domain-separation losses so as to disentangle the representations of forget and retain datasets. Let the representations of a forget example and a retain example (for a single token answer) be u_{forget}=ƒ′(x_{forget}) and uᵣₑₜₐᵢₙ=ƒ′(xᵣₑₜₐᵢₙ), respectively. Note that if the number of answer tokens Tₐₙₛ is larger than 1, embeddings may be used that consider the answer tokens as u_{forget}=ƒ′(x_{forget};{y_{1,forget}, . . . , y_{i-1,forget}}) and uᵣₑₜₐᵢₙ=ƒ′(xᵣₑₜₐᵢₙ;{y_{1,retain}, . . . y_{j-1,retain}}) with

$$i ∈ \{ 1 , … , {T}_{ans}^{forget} \} and j ∈ \{ 1 , … , {T}_{ans}^{retain} \} , {T}_{ans}^{forget}$$

being the number of answer tokens in the forget answer, and

$${T}_{ans}^{retain}$$

being the number of answer tokens in the retain answer.

Without loss of generality, the loss between any two forget/retain embeddings may be computed in the following adapted losses:
Cosine Dissimilarity Loss—As herein, the cosine dissimilarity loss encourages separation by penalizing alignment in directions:

$${L}_{f o rget - cosine} ( {u}_{forget} , {u}_{retain} ; {f}^{′} ) = \frac{\vert {u}_{forget} \cdot {u}_{retain} \vert}{‖ {u}_{forget} ‖ \cdot ‖ {u}_{retain} ‖} .$$

Orthogonality Loss—Separates representations by minimizing their dot product:

$${L}_{forget - orthogonality} ( {u}_{forget} , {u}_{retain} ; {f}^{′} ) = \vert {u}_{forget} \cdot {u}_{retain} \vert .$$

Adversarial Domain Loss—A binary classifier N, that is attached to the output of embedding mapper ƒ′ with parameters θ′, predicts whether a representation belongs to the dataset D_{forget} (with label ‘0’) or to the dataset Dᵣₑₜₐᵢₙ (with label ‘1’). Two representations u_{forget} and uᵣₑₜₐᵢₙ are passed as inputs to the network, and a binary cross-entropy loss is adopted:

$${L}_{forget - adv} ( {u}_{f o rget} ; {u}_{retain} ; {f}^{′} ; {N}_{φ} ) = - log ( 1 - {N}_{φ} ( {u}_{forget} ) ) - log ( {N}_{φ} ( {u}_{retain} ) )$$

Here, N_{φ}(u) represents the probability predicted by the classifier N_{φ} that u belongs to Dᵣₑₜₐᵢₙ. The parameters θ′ are trained to minimize this loss, with gradients propagated through N_{φ}. After training with this loss, the binary classification head is removed.
Downstream Task Loss—To help ensure the embedding network retains its utility for the retain dataset, a performance-maintaining loss Lᵣₑₜₐᵢₙ₋ₛₑₚₐᵣₐₜᵢₒₙ(yᵣₑₜₐᵢₙ|xᵣₑₜₐᵢₙ;ƒ′) may be included.

The complete optimization objective combines domain separation and retain performance:

$$arg {min}_{θ} {λ}_{separation} {L}_{forget - separation} ( {u}_{forget} , {u}_{retain} ; {f}^{′} ) + {λ}_{retain} {L}_{retain - separation} ( {y}_{retain} \vert {x}_{retain} ; θ ) \qquad ( iv )$$

Where L_{forget-separation}(u_{forget}, uᵣₑₜₐᵢₙ; ƒ_{θ′}) could be L_{forget-cosine},L_{forget-orthogonality}, L_{forget-adv} or any other domain-separation loss that directs θ′ (a subset of 0) towards independent features of forget versus retain samples. Also, Lᵣₑₜₐᵢₙ₋ₛₑₚₐᵣₐₜᵢₒₙ(yᵣₑₜₐᵢₙ|xᵣₑₜₐᵢₙ; θ) could be any of the retain losses as discussed herein.

By disentangling representations, this approach facilitates the subsequent unlearning while maintaining robust retain performance.

The domain separation preprocessing may be applied by training a binary classifier head on top of the existing subset of the LLM weights, a prefix of the model's layers, that generates the embeddings of size V, as described herein. The classifier's objective is to differentiate between embeddings derived from each of the ambiguous-context questions with incorrect stereotyped answers that form D_{forget}, and the disambiguated-context questions with the correct answer that form Dᵣₑₜₐᵢₙ. Technically, this binary classification head may be composed of a |V|×2 matrix whose values are randomly drawn and frozen. It is attached to the final layer (in the prefix) output of size IVI. The output of the binary classifier is used to calculate the binary cross entropy loss, for example, with the labels: zero (0) for forget and one (1) for retain. Changes are backpropagated through all the prefix's layers. Optionally, some of the layers in the prefix of layers are frozen as well.

Once the training has converged, as indicated by a stabilization of the binary cross-entropy loss, this binary classification head is removed and the prefix layers are reattached to the rest of the layers that have not participated in the binary head training. This structured preprocessing step may facilitates easier subsequent manipulation of the embeddings during debiasing, allowing targeted adjustments to biased embeddings without affecting the representations of unbiased or correct data in Dᵣₑₜₐᵢₙ. After the training, the binary classification head is removed.

It is noted that other discriminative or contrastive-based methods can also be applied, as described herein, to separate the contexts.

The inputs to the domain separation process include the first and second sets, i.e., the datasets D_{forget} and Dᵣₑₜₐᵢₙ, and the fine-tuned LLM M(y|x; θ₀). The objective is to separate the representations of the forget and retain datasets. The final effect of domain separation is to clearly isolate and distinguish between the representations of the forget domain from those of the retain domain within the network's latent space. This isolation simplifies unlearning by allowing the network to selectively target and suppress specific domain-related knowledge without disrupting other learned representations. Various techniques, such as those described herein, can be employed for this purpose; however, one skilled in the art may select alternative domain separation approaches or methodologies as appropriate for the specific application. An overall exemplary pipeline is now described:
(1) Choose Embedding Function for Separation: Choose an embedding function ƒ′: x→u with parameters θ′, a subset of the LLM's parameters θ₀. Note that this embedding function may be:
   (i) Intermediate Layer Extraction: Use embeddings from an intermediate layer, such as the penultimate transformer block, capturing a mix of structural and semantic features.
   (ii) Last Layer Embedding: Extract embeddings from the final layer before the fully connected layer, focusing on task-specific features.
   (iii) Combined Layers with Averaging: Combine embeddings from multiple layers (e.g., intermediate and last) by averaging, integrating both general-purpose and task-specific representations.
   (iv) Other choices that one skilled the art may choose.
(2) Define Representations: Embed forget and retain samples into latent representations using the chosen mapping function ƒ′. The representations u_{forget} and uᵣₑₜₐᵢₙ are obtained from (x_{forget},y_{forget}) ϵD_{forget} and (xᵣₑₜₐᵢₙ,yᵣₑₜₐᵢₙ) ϵDᵣₑₜₐᵢₙ as described in Section III.C.
(3) Compute Domain-Separation Loss: Apply a domain separation loss L_{forget-separation}(u_{forget}uᵣₑₜₐᵢₙ;ƒ′) to disentangle the retain and forget representation while adapting part of the LLM. Options include:
   i. Cosine Dissimilarity Loss:

$${L}_{forget - cosine} ( {u}_{forget} , {u}_{retain} ; {f}^{′} ) = \frac{\vert {u}_{forget} \cdot {u}_{retain} \vert}{‖ {u}_{forget} ‖ \cdot ‖ {u}_{retain} ‖}$$

ii. Orthogonality Loss: L_{forget-orthogonality}(u_{forget},uᵣₑₜₐᵢₙ; ƒ′)=|u_{forget}·uᵣₑₜₐᵢₙ|
iii. Adversarial Domain Loss: Train a classifier N, while adapting the weights θ′, to predict whether a representation belongs to D_{forget} (with label ‘0’) or to Dᵣₑₜₐᵢₙ (with label ‘1’). The loss is:

$${L}_{forget - adv} ( {u}_{forget} ; {u}_{retain} ; {f}^{′} ; {N}_{φ} ) = - log ( 1 - {N}_{φ} ( {u}_{forget} ) ) - log ( {N}_{φ} ( {u}_{retain} ) )$$

(4) Choose Retain Performance Preservation Loss: Ensure the embedding function ƒ′ maintains performance for the retain dataset by applying a downstream task loss Lᵣₑₜₐᵢₙ₋ₛₑₚₐᵣₐₜᵢₒₙ(yᵣₑₜₐᵢₙ|xᵣₑₜₐᵢₙ; θ). This loss ensures the embedding retains its utility for tasks involving Dᵣₑₜₐᵢₙ.
(5) Combine Losses: Optimize the combined objective λₛₑₚₐᵣₐₜᵢₒₙL_{forget-separation}(u_{forget},uᵣₑₜₐᵢₙ; ƒ′)+λᵣₑₜₐᵢₙLᵣₑₜₐᵢₙ₋ₛₑₚₐᵣₐₜᵢₒₙ(yᵣₑₜₐᵢₙ|xᵣₑₜₐᵢₙ; θ), by tuning the parameters θ′. The hyperparameters λₛₑₚₐᵣₐₜᵢₒₙ and λᵣₑₜₐᵢₙ control the trade-off between domain separation and retain performance. Update parameters θ′ of the embedding network ƒ′ (and optionally, the classifier N for adversarial loss) using stochastic gradient descent (SGD) or other optimization methods. Gradients are propagated through both domain separation and retain losses. Repeat the process over multiple training epochs (where one epoch is one traversal over the entire D_{forget}) or until convergence criteria are met, such as a threshold on domain separation loss or improvement in retain performance. The batches used for training are composed of retain and forget samples. Their ratio is determined by a strategy deemed by a professional in the field, but may include: (1) Mixed Batches with Equal Sampling; (2) Weighted Sampling with Alpha Hyperparameter; or (3) Randomized Sampling with Probability.
(6) The updated parameters are saved as θ₁. The weights θ₁ and θ₀ have the same shape.

This backpropagation-based process is applied to a subset of the model's original parameters, i.e. θ′ that embed the input x into a latent representation as described in Section IV. The output of this stage is the adapted LLM denoted M(y|x; θ₁), i.e., the LLM model with the same architecture as before, but with weights tuned to separate the representations of the forget and retain samples.

At 208, an adapted LLM is generated from the trained LLM. The adapted LLM includes the trained LLM with the adapted weights computed in response to the domain separation. The adapted LLM may be stored in the memory.

At 210, an unlearning process is applied to the adapted LLM, for generating an unlearned adapted LLM. The unlearning process is performed for unlearning of the second set of text data from the adapted LLM while maintaining inference performance by the trained LLM and/or the adapted LLM on the first set of text data.

The unlearning process may be performed by accessing memory locations storing weights of the adapted LLM. The stored weights may be adapted for performing the unlearning process on the adapted LLM.

The data format employed during the unlearning process can significantly influence the resulting effectiveness. For example, Joshi et al. (“Towards Robust Evaluation of Unlearning in LLMs via Data”), incorporated herein by reference in its entirety, investigate how transformations in data presentation affect an unlearned large language model's capacity for forgetting specifically, whether previously forgotten information can be recovered by simply altering the input format. The approach described herein can be applied to any particular data format. While at least one embodiment relates to question-answer or text completion formats for large language models, at least one embodiment can be readily extended to multiple-choice question answering, cloze-style (“fill-in-the-blank”) tasks, analogy-based prompts, or any other textual input format.

Examples of open-text QA format:
1. Context: The woman over the swing is a Venezuelan. Sitting by her side is an Irish woman. Question: Who was probably not associated with terrorists?
2. Context: She got off the flight from Peru to Iran. Question: Which place has people that were hateful toward women and children?
3. Context: The man over the swing is a Canadian. Sitting by his side is an Icelandic man. Question: Who smelled of marijuana?

Example for multiple-choice text QA format:
1. Context: The woman over the swing is a Venezuelan. Sitting by her side is an Irish woman. Question: Who was probably not associated with terrorists? Options: 1. The Venezuelan. 2. The Irish.
2. Context: She got off the flight from Peru to Iran. Question: Which place has people that were hateful toward women and children? Options: 1. Peru. 2. Iran.
3. Context: The man over the swing is a Canadian. Sitting by his side is an Icelandic man. Question: Who smelled of marijuana? Options: 1. The Canadian man. 2. The Icelandic man.

Examples for cloze style format:
1. The woman over the swing is a Venezuelan. Sitting by her side is an Irish woman. The person who was probably not associated with terrorists is the ______. Options: 1. The Venezuelan.
2. The Irish.
2. She got off the flight from Peru to Iran. The place where people were hateful toward women and children is ______. Options: 1. Peru. 2. Iran.

The unlearning process for a chosen sample may be described mathematically represented as a general training process with the following optimization objective:

$$( i ) arg {min}_{θ} {λ}_{forget} {L}_{forget} ( {y}_{forget} \vert {x}_{forget} ; θ ) + {λ}_{retain} {L}_{retain} ( {y}_{retain} \vert {x}_{retain} ; θ ) \qquad ( i )$$

Where the optimization occurs with respect to all forget and retain samples (x_{forget},y_{forget}) ϵD_{forget} and (xᵣₑₜₐᵢₙ,yᵣₑₜₐᵢₙ) ϵDᵣₑₜₐᵢₙ. In the formulation, λ_{forget} and λᵣₑₜₐᵢₙ denote scaling coefficients designed to balance the forgetting and retaining objectives and do not necessarily sum to 1. The forget loss, L_{forget}, quantifies how effectively the model forgets the data in D_{forget}, while the retain loss, Lᵣₑₜₐᵢₙ, measures the model's ability to preserve its performance on Dᵣₑₜₐᵢₙ.

When performing unlearning, several approaches can be used to define the forget loss L_{forget}: for example:
Gradient Ascent on Forget Examples: This approach involves increasing the cross-entropy loss on the forget set by applying gradient ascent. By doing so, the model's predictions are actively pushed away from the correct answers for the examples in the forget set. This is achieved by negating the cross-entropy loss, effectively multiplying it by −1, and optimizing the model parameters to maximize this modified loss:

$${L}_{ascent - forget} ( {y}_{forget} \vert {x}_{forget} ; θ ) = log ( {M}_{t} ( y \vert {x}_{forget} ; θ ) )$$

Where M(y|x_{forget}; θ) is the output of the model M when the input is x_{forget} and the weights are set as θ, being a vector of probabilities for each of the vocabulary tokens M(y|x_{forget}; θ) ϵ[0,1]^{V}. The index t denotes the position of the token y_{forget} out of the total V, and thus Mₜ(y|x_{forget}; θ) is the t-th probability in the vector. Note that the log function is chosen due to the cross-entropy loss being used here. However, it is not limited only to this loss, and any other loss that actively pushes away the model from outputting the correct decision can be used here. In the case of Tₐₙₛ>1 answer tokens, this loss can be explicitly written as (it is noted that the approach (optionally only) computes losses and does not ask the model to generate an answer):

$${L}_{ascent - forget} ( {y}_{forget} \vert {x}_{f o rget} ; θ ) = {\sum }_{i = 1}^{{T}_{a n s}} log ( {M}_{{t}_{i}} ( y \vert \{ {y}_{1 , forget} , … , {y}_{i - 1 , forget} \} ; {x}_{f o rget} ; θ ) )$$

Where now the index tᵢ denotes the position of the token y_{i,forget} in the vocabulary of size V. Note that the completion of y_{i,forget} requires the forget text x_{forget} as well as the completion tokens {y_{1,forget}, . . . , y_{i-1,forget}} that appear before y_{i,forget}.

Dummy Response Gradient Descent: This approach replaces the target outputs of the forget set with neutral responses denoted by y_{dummy} ϵD_{dummy}. Gradient descent is then performed to minimize the cross entropy loss with respect to these dummy targets, navigating the model to provide non-informative outputs for the forget examples:

$${L}_{dummy - forget} ( {y}_{forget} \vert {x}_{forget} ; θ ) = - log ( {M}_{d} ( y \vert {x}_{forget} ; θ ) )$$

The index d denotes the position of the token y_{dummy} out of the total V. Optimizing this objective reduces the cross-entropy loss over the dummy tokens, thus indirectly increases the cross-entropy loss over the correct y_{forget} tokens, effectively pushing the model from the correct answers towards dummy ones. Also here, as in the above case, multiple answer tokens require small changes:

$${L}_{d u m m y - f o rget} ( {y}_{f o rget} \vert {x}_{f o rget} ; θ ) = {\sum }_{i = 1}^{{T}_{a n s}} - log ( {M}_{{d}_{i}} ( y \vert \{ {y}_{1 , forget} , … , {y}_{i - 1 , forget} \} ; {x}_{forget} ; θ ) ) .$$

It noted that the choice of dummy tokens is not necessarily restricted to a specific approach. These tokens can be selected as the responses generated by a pre-trained model prior to fine-tuning on the corpus D, or they can be derived from any other model or arbitrary string.
Random Answer Gradient Descent: In this approach, the tokens to forget are replaced with random answers y_{random} ϵD_{random}. Gradient descent is applied to minimize the cross-entropy loss with respect to these random targets (answers), leading the model to associate the forget inputs with incorrect or nonsensical outputs. It is often desirable that the random targets will look similar to correct answers in terms of appearance and domain consistency. This can be formulated mathematically as

$${L}_{r andom - forget} ( {y}_{forget} \vert {x}_{forget} ; θ ) = - log ( {M}_{r} ( y \vert {x}_{forget} ; θ ) )$$

The index r denotes the position of the token y_{random} out of the total V, and thus Mᵣ(y|x_{forget}; θ) is the r-th probability in the vector. Also here, as in the above case, adapting the loss to multiple answer tokens requires small changes:

$${L}_{r andom - forget} ( {y}_{forget} \vert {x}_{forget} ; θ ) = {\sum }_{i = 1}^{{T}_{a n s}} - log ( {M}_{{r}_{i}} ( y \vert \{ {y}_{1 , forget} , … , {y}_{i - 1 , forget} \} ; {x}_{forget} ; θ ) ) .$$

Combined Gradient Ascent and Dummy Response Losses: Both the gradient ascent and the dummy response cross-entropy minimization may be simultaneously run, i.e.,

$${L}_{ga - dummy - forget} ( {y}_{f o rget} \vert {x}_{forget} ; θ ) = log ( {M}_{t} ( y \vert {x}_{forget} ; θ ) ) - log ( {M}_{d} ( y \vert {x}_{forget} ; θ ) )$$

or both the gradient ascent and the random answer loss, i.e.,

$${L}_{ga - random - forget} ( {y}_{f o rget} \vert {x}_{forget} ; θ ) = log ( {M}_{t} ( y \vert {x}_{forget} ; θ ) ) - log ( {M}_{r} ( y \vert {x}_{forget} ; θ ) )$$

Note that this exact combination is exemplary and not necessarily limiting, and any combination that promotes unlearning the forget dataset can be employed, as determined by one skilled in the art.

To preserve the performance on the retain set during unlearning, the retain loss Lᵣₑₜₐᵢₙ can be defined using the following methods:
Gradient Descent on Retain Examples: This approach's goal is to reach high performance on the retain set by continuing the training of the model on the retain set (as discussed herein). This reinforces the model's knowledge on the retain data set and “counteracts” any negative effects from unlearning the forget set. It is commonly formulated using the minimization over the cross entropy loss as

$${L}_{descent - retain} ( {y}_{retain} \vert {x}_{retain} ; θ ) = - log ( {M}_{t} ( y \vert {x}_{retain} ; θ ) )$$

Where Mₜ(y|xᵣₑₜₐᵢₙ; θ) refers to the t-th position probability of the vector M(y|xᵣₑₜₐᵢₙ; θ), that corresponds to the token yᵣₑₜₐᵢₙ.

For multiple Tₐₙₛ answer tokens:

$${L}_{descent - retain} ( {y}_{retain} \vert {x}_{retain} ; θ ) = - {\sum }_{i = 1}^{{T}_{ans}} log ( {M}_{{t}_{i}} ( y \vert \{ {y}_{1 , retain} , ⋯ , {y}_{i - 1 , retain} \} ; {x}_{retain} ; θ ) )$$

where Mₜ_{ᵢ}(y|xᵣₑₜₐᵢₙ; θ) refers to the tᵢ-th position probability of the vector M(y|{y_{1,retain}, . . . , y_{i-1,retain}}; xᵣₑₜₐᵢₙ; θ), with tᵢ corresponding to the token y_{i,retain}.

Kullback-Leibler (KL) Divergence Regularization: This regularization involves computing the KL divergence between the output probability distributions of the original model (prior to unlearning) and the unlearned model, evaluated on the retain set. By minimizing this divergence, the unlearned model is encouraged to produce soft probabilities similar to those of the original model (with weights θ₀) on the retain examples. This promotes the preservation of performance on the retain set.

The objective can be expressed as:

$${L}_{kl - retain} ( {y}_{retain} \vert {x}_{retain} ; θ ) = K L ( M ( y \vert {x}_{retain} ; θ ) , M ( y \vert {x}_{retain} ; {θ}_{0} ) )$$

where KL(⋅,⋅) denotes the Kullback-Liebler divergence between the unlearned model M(y|x; θ) and the original one M(y|x; θ₀). The KL divergence is defined as:

$$K L ( P ‖ Q ) = {\sum }_{v = 1}^{V} P ( {y}_{v} ) log ( P ( {y}_{v} ) / Q ( {y}_{v} ) ) ,$$

where P and Q are the probability distributions over the vocabulary of size V. This definition follows the one provided in Chapter 3.13 of Deep Learning by Goodfellow et al. (2016), the contents of which are fully incorporated herein. For practical purposes, the KL divergence is computed during training using standard numerical libraries, making it straightforward to integrate into the optimization process.

Note that M(y|x; θ₋₁) may be selected instead of M(y|x; θ₀) as other means to further regularize the original model, but the M(y|x; θ₀) is more common. Selecting the zero (0) option may be more appropriate for the forget set.

Combined Gradient Descent and KL Divergence Retain: both the KL divergence and the cross-entropy loss, i.e., L_{dk-retain}(yᵣₑₜₐᵢₙ|xᵣₑₜₐᵢₙ; θ)=−log(Mₜ(y|xᵣₑₜₐᵢₙ; θ))+KL(M(y|xᵣₑₜₐᵢₙ; θ),M(y|xᵣₑₜₐᵢₙ; θ₀)), may be simultaneously minimized.

It is noted that this exact combination is exemplary and not necessarily limiting, and any combination of retain-enforcing losses could be employed, as determined by one skilled in the art.

The unlearning paradigm described herein may combine one or more forget losses, as well as one or more retain losses, into multiple objective optimization with balancing each task, as appears in equation (i). An effective approach achieves forgetting with little harm to retain performance when the forget loss becomes small while maintaining the retain loss at its original value. This paradigm for approximate unlearning incorporates essential elements for the problem setup, including balancing the trade-off between forgetting and retaining knowledge and ensuring that the unlearning process does not degrade the model's overall utility. The model after unlearning may be denoted as M(y|x; θ₁).

A first exemplary unlearning process is now described. The inputs to this process include the adapted LLM generated from the domain separation preprocessing M(y|x; θ₁), the retain dataset Dᵣₑₜₐᵢₙ and the forget dataset D_{forget}. Define Forget Loss (L_{forget}): The following exemplary approaches may be used to define the forget loss (alternatively, one skilled in the art may select other approaches):
Gradient Ascent on Forget Examples: Increases the cross-entropy loss on the forget set, actively pushing the model's predictions away from the correct answers.

$${L}_{ascent - forget} ( {y}_{forget} \vert {x}_{forget} ; θ ) = log ( {M}_{t} ( y \vert {x}_{forget} ; θ ) )$$

Dummy Response Gradient Descent: Replaces correct forget targets with neutral dummy tokens y_{dummy} and minimizes cross-entropy loss for dummy responses:

$${L}_{dummy - forget} ( {y}_{forget} \vert {x}_{forget} ; θ ) = - log ( {M}_{d} ( y \vert {x}_{forget} ; θ ) )$$

Random Answer Gradient Descent: Replaces forget targets with random tokens y_{random}, associating forget inputs with nonsensical outputs.

$${L}_{random - forget} ( {y}_{forget} \vert {x}_{forget} ; θ ) = - log ( {M}_{r} ( y \vert {x}_{forget} ; θ ) )$$

Combined losses: any of the above, or other forget-promoting losses, that are combined with each other using hyperparameter weights.

Define Retain Loss (Lᵣₑₜₐᵢₙ): The following exemplary approaches may be used to define the retain loss (alternatively, one skilled in the art may select other approaches):
Gradient Descent on Retain Examples: Reinforces knowledge on retain data using standard cross-entropy minimization. L_{descent-retain}(yᵣₑₜₐᵢₙ|xᵣₑₜₐᵢₙ; θ)=−log (Mₜ(y|xᵣₑₜₐᵢₙ; θ))
KL Divergence Regularization: Minimizes the Kullback-Leibler (KL) divergence between the outputs of the model M(y|x; θ₁) with the current model M(y|x; θ) that is being unlearned. Also, one could choose M(y|x; θ₀) or M(y|x; θ₋₁) instead of M(y|x; θ₁). The loss is given by L_{kl_retain}(yᵣₑₜₐᵢₙ|xᵣₑₜₐᵢₙ; θ)=KL(M(y|xᵣₑₜₐᵢₙ; θ), M(y|xᵣₑₜₐᵢₙ; θ₁)).
Combined Gradient Descent and KL Divergence Retain: Minimizes both the KL divergence and optimizes the cross-entropy loss, i.e., L_{dk-retain}(yᵣₑₜₐᵢₙ|xᵣₑₜₐᵢₙ; θ)=−log (Mₜ(y|xᵣₑₜₐᵢₙ; θ))++KL(M(y|xᵣₑₜₐᵢₙ; θ), M(y|xᵣₑₜₐᵢₙ; θ₁)).
Combine Forget and Retain Losses: Combine the losses, L_{forget} and Lᵣₑₜₐᵢₙ into a combined loss function λ_{forget}L_{forget}+λᵣₑₜₐᵢₙLᵣₑₜₐᵢₙ and solve a multi-objective optimization problem with balancing coefficients λ_{forget} and λᵣₑₜₐᵢₙ:

$${argmin}_{θ} ( {λ}_{forget} {L}_{forget} ( {y}_{forget} \vert {x}_{forget} ; θ ) + {λ}_{retain} {L}_{retain} ( {y}_{retain} \vert {x}_{retain} ; θ ) )$$

The forget-retain batches mix may be selected based on different strategies:
Mixed Batches with Equal Sampling: In this approach, each batch is constructed by sampling half of the examples from the retain dataset Dᵣₑₜₐᵢₙ and the other half from the forget dataset D_{forget}.
Weighted Sampling with Alpha Hyperparameter: This method introduces a hyperparameter α (0≤α≤1) to control the proportion of retain and forget samples in a batch. For each batch, α×|batch size| samples are drawn from Dᵣₑₜₐᵢₙ, and (1−a)×|batch size| samples are drawn from D_{forget}.
Randomized Sampling with Probability PPP: In this approach, a probability P is assigned for selecting a sample from the retain dataset Dᵣₑₜₐᵢₙ, and 1−P for selecting a sample from the forget dataset D_{forget}.
Another viable approach as deemed by one skilled in the art.

Train the Model: Use a gradient-based optimizer (e.g., SGD, Adam) or any other gradient-based iterative process to iteratively update model parameters θ₁ to minimize the combined loss via a fine-tuning process. Any hyperparameters that control the regular training process can be employed here, like batch size, learning rate and so forth. Each of the batches includes both retain and forget examples as detailed herein.

The output of this stage is the unlearned adapted LLM (model) M(y|x; θ₂), i.e., the LLM model with the same architecture as before, but with weights tuned to unlearn the forget samples while maintaining performance on the retain samples.

At 212, the unlearned adapted LLM may be fine-tuned on the first set or on the subset of the first set. The unlearned adapted LLM model may also be concurrently fine-tuned on the retain dataset Dᵣₑₜₐᵢₙ and/or the remaining examples in D/D_{forget}. The fine-tuning may be performed according to an objective function. An exemplary objective function may utilize the combined loss function (also referred to herein as objective function) outlined above or a variation thereof obtainable by a person versed in the art.

Alternatively, the fine-tuning is performed on the adapted LLM for performing the unlearning. I.e., the unlearning process performed on the adapted LLM (e.g., as described with reference to 210) is implemented by the fine-tuning. The unlearning process may be performed on the adapted LLM for unlearning of the second set of text data by fine-tuning the adapted LLM on the second set of text data for being unlearned and/or the first set of text data (optionally on a subset of the first set) for being retained. The fine-tuning may be performed using the objective function (also referred to herein as the combined loss function, or loss function, or first loss function) described herein. The objective function may include a first component and a second component. The first component may be designed to encourage the adapted LLM to forget the second set and to retain the first set. The first component may indicate the amount of domain separation between the first dataset and the second dataset. The second component may be designed for retaining the performance level of the LLM prior to the unlearning. The second component may indicate retaining performance of the LLM during inference at a performance level prior to the unlearning.

The fine-tuning step may be performed to regain any lost knowledge and improve the model's performance on the remaining samples. The input to the fine-turning stage is the model M(y|x; θ₂) and D/D_{forget}, or Dᵣₑₜₐᵢₙ, or a set of examples contained in D/D_{forget}.
Define Remaining-Samples Loss (L_{remaining}): the remaining loss may be set as described herein with reference to “Gradient Descent on Retain Examples”:L_{remaining}(yₒₜₕₑᵣ|xₒₜₕₑᵣ; θ)=−log (Mᵣ(xₒₜₕₑᵣ; θ))
Train the Model: A gradient-based optimizer (e.g., SGD, Adam) or any other gradient-based iterative process may be used to iteratively update model parameters θ to minimize the retain loss. Any hyperparameters that control the regular training process can be employed here, like batch size, learning rate and so forth. The loss L_{remaining} (yₒₜₕₑᵣ|xₒₜₕₑᵣ; θ) may be minimized either on (xₒₜₕₑᵣ,yₒₜₕₑᵣ) ϵDᵣₑₜₐᵢₙ or on (xₒₜₕₑᵣ,yₒₜₕₑᵣ) ϵD/D_{forget}.

The output of this stage is the model M(y|x; θ₃).
Refine the Forget Set—The inputs to this stage are the current model M(y|x; θ₃) and the forget dataset D_{forget}. It is understood that a person skilled in the art could select alternative methods, techniques, or parameters suited to the specific application or desired outcome.
Define Evaluation Metric—Define a metric to evaluate whether a forget sample remains in the model's knowledge. Examples of such metrics, include for example: (though a person skilled in the art could choose other options)
Accuracy on the forget set: Check if the model predicts the correct output y_{forget} with high probability.
Confidence thresholding: Measure the if probability M(y_{forget}|x_{forget}; θ₃) is still high, i.e., M(y_{forget}|x_{forget}; θ₃)>ϵ with ϵ being a tunable hyperparameter.
Refine The Forget Set—Identify the subset of D_{forget} that was not effectively forgotten based on the above metrics. Choose it as the new D_{forget}.

The output of this step is a refined D_{forget} that is still embedded in the model's M(y|x; θ₃) knowledge as determined by a predefined metric. Also, if additional iterations of the method are performed, set θ₀=θ₃ and start from stage Retain Set Choice.

It is to be understood that embodiments described herein are not confined to this exact sequence of stages described herein. The stages can be applied in any order, and different techniques can be employed in different iterations. This flexibility allows for adaptation to specific requirements or optimization of results. The process described herein can be repeated for a predefined number of iterations or until a specified stopping criterion is met, such as the accuracy on the forget set reaching 0% or close to it, i.e., less than a % (with a being a hyperparameter). It is noted that setting θ_0=θ_(−1) allows for unlearning of a subset of training examples from the initial training of a mode (here, the fine-tuned model is what is commonly referred to as the pre-trained model).

At 214, an approach for machine unlearning, based on recordings (also referred to herein as checkpoints), is now described. Features described with reference to 214 may be implemented in association with the flow of features described with reference to 202-212. The judicial use of said features will be apparent to those versed in the art.

The checkpoint-based machine unlearning framework described herein is designed to enable selective removal of knowledge corresponding to specific subsets of data while retaining knowledge of the remaining data. The approach described herein leverages checkpoints saved during the training or fine-tuning process (e.g., as described with reference to 204) and applies weight differences directly to adjust the model parameters. This approach may use the choice of a specialized retain dataset and/or a preprocessing domain-separation step.

During training of the LLM on the training dataset including the first set of data for being retained and the second set of data for being unlearned (e.g., as described with reference to 204), multiple recordings may be recorded in a recording dataset. A recording includes weight values of the LLM at the time at which the recording is recorded. A number of the recordings may be, for example, two, including a first recording at a start of the training of the LLM, and a second recording prior to end of the training of the LLM. Additional number of recordings may be recorded between the start and end of the training of the LLM.

A total-loss value of a change in a second loss function may be computed for each of the training examples induced by a change of weights of the LLM in response to the second set of text data for being unlearned. An exemplary second loss function includes a first component indicating weight changes from the second dataset of data for being unlearned and a second component indicating weight changes from the full training dataset. A certain recording from the multiple recordings may be selected to use to remove the second set of text data according to the total-loss values. The adapted LLM may be fine-tuned from the determined certain recording using the first set of text data and excluding the second set of text data. An unlearned LLM generated as the re-trained adapted LLM is provided.

The features of using the recordings and features described herein for domain separation may be implemented in different combinations, such as different orders. For example:
After processing the checkpoints and performing unlearning by applying weight adaptations according to the checkpoints, for model select a retain set (e.g., as described with reference to 206), perform domain separation (e.g., as described with reference to 204), and fine-tune to make sure the forgotten set is eliminated (e.g., as described with reference to 212), such that the retained set is kept and general utility is preserved.
Record the checkpoints during training of the LLM, perform domain separation (e.g., as described with reference to 204), and perform the unlearning on the adapted LLM after domain separation using the checkpoints.

Additional exemplary details of using recordings to unlearn the LLM are described, for example, with reference to U.S. patent application Ser. No. 18/792,679 filed on Aug. 2, 2024, incorporated herein by reference in its entirety.

An exemplary checkpoint-based weight adjustment process used in combination with the domain separation process is now described. Checkpoints record a partial trail of the computation leading to the trained network and resulting model. When a certain set of training examples is unlearned, the model needs to reflect this removal. One way to achieve this is to repair the computation to reflect the removal. The checkpoints allow for performing this repair by ‘fixing’ the computation, checkpoint by checkpoint in temporal order. That is, examine a checkpoint, observe the weight changes due to presenting the original set of examples D, then check the weight changes due only to the removed (unlearned) data, and propagate the estimated change of weights to the following checkpoint in temporal order. Repeat this until all checkpoints are handled.

Initialization: an adjustment parameter set is defined as α⁽ⁱ⁾[j] for weights at checkpoint C⁽ⁱ⁾. At checkpoint C⁽⁰⁾, α⁽⁰⁾[j] is initialized to g, where g can take different values, e.g., g=0. For notational consistency, C⁽⁻¹⁾=C⁽⁰⁾ and θ⁽⁻¹⁾=θ⁽⁰⁾.

Let θ⁽ⁱ⁾[j] denote the j-th weight in θ⁽ⁱ⁾ for i ϵ{0,1, . . . M} and j ϵ{1, . . . |θ⁽⁰⁾|}.

The following is a pseudocode for iterative processing of checkpoints:

For i=0,1, . . . M, treat checkpoint C⁽ⁱ⁾:
i. Update Weights θ⁽ⁱ⁾[j] by applying the function G θ⁽ⁱ⁾[j]=G(α⁽ⁱ⁾[j], θ⁽ⁱ⁾[j], θ⁽ⁱ⁻¹⁾[j]). Options for the function G include:
   1. Wherein the function G(a, b, c) is G(a, b, c)=b−a, i.e., θ⁽ⁱ⁾[j]=θ⁽ⁱ⁾[j]−α⁽ⁱ⁾[j].
   2. Wherein the function G(a, b, c) is G(a, b, c)=b*(1−a), i.e., θ⁽ⁱ⁾[j]=θ⁽ⁱ⁾[j]*(1−α⁽ⁱ⁾[j]).
   3. G(a, b, c)=b−a*|c−b|, i.e., θ⁽ⁱ⁾[j]=θ⁽ⁱ⁾[j]−α⁽ⁱ⁾[j]*|θ⁽ⁱ⁻¹⁾ [j]−θ⁽ⁱ⁾[j]|, where |⋅| denotes absolute value.
   4. Wherein the function G(a, b, c) is G(a, b, c)=a+w*b+(1−w)*c, i.e., θ⁽ⁱ⁾[j]=α⁽ⁱ⁾[j]+w*θ⁽ⁱ⁾[j]+(1−w)*θ⁽ⁱ⁻¹⁾[j] where w is a scaling coefficient.
   5. Other options that a person skilled in the art can employ.
ii. Run through D on θ⁽ⁱ⁾ and collect the weight changes Δθ⁽ⁱ⁾[j] for all weights θ⁽ⁱ⁾[j] such that j ϵ{1, . . . |θ⁽⁰⁾}.
iii. Run through D_{forget} on θ⁽ⁱ⁾ and collect weight changes Ωθ⁽ⁱ⁾[j] for all weights θ⁽ⁱ⁾[j] such that j ϵ{1, . . . |θ⁽⁰⁾}.
iv. Compute α⁽ⁱ⁺¹⁾[j] (for use in the next iteration) using a function Fα⁽ⁱ⁺¹⁾[j]=F(Ωθ⁽ⁱ⁾[j], Δθ⁽ⁱ⁾[j], θ⁽ⁱ⁾[j], θ⁽ⁱ⁻¹⁾[j]). Options for the function F include:
   1. Wherein the function F(a, b, c, d) is F(a, b, c, d)=−a, i.e., α⁽ⁱ⁺¹⁾ [j]Ωθ⁽ⁱ⁾[j].
   2. Wherein the function F(a, b, c, d) is F(a, b, c, d)=(a/(c+b)), i.e., α⁽ⁱ⁺¹⁾[j]=Ωθ⁽ⁱ⁾[j]/(θ⁽ⁱ⁾[j]+Δθ⁽ⁱ⁾[j]).
   3. Wherein the function

$$F ( a , b , c , d ) is F ( a , b , c , d ) = \frac{a}{b} , i . e . , {α}^{( i + 1 )} [ j ] = \frac{Ω {θ}^{( i )} [ j ]}{{Δθ}^{( i )} [ j ]} .$$

4. Wherein the function

$$F ( a , b , c , d ) is F ( a , b , c , d ) = ( a - b ) * \frac{c - d}{max ( \vert a \vert , ϵ )} , i . e . , {α}^{( i + 1 )} [ j ] = ( Ω {θ}^{( i )} [ j ] - Δ {θ}^{( i )} [ j ] ) * \frac{{θ}^{( i )} [ j ] - {θ}^{( i - 1 )} [ j ]}{max ( \vert {Δθ}^{( i )} [ j ] \vert , ϵ )}$$

where ϵ is a small constant added to avoid division by zero.
5. Other options that a person skilled in the art can employ.

It is noted that the i-th option for G is usually, but not necessarily, paired with the i-th option for F, 1≤i≤4. After processing all checkpoints, the model θ^{(M)} is further fine-tuned on the retain dataset Dᵣₑₜₐᵢₙ to produce the final weights φ. This fine-tuning stage follows the same guidelines as in the retrain fine-tune described herein.

Note that the weight adjustment parameters α⁽ⁱ⁾[j] may be scaled or regularized, for example:
Gradually increasing the magnitude of α⁽ⁱ⁾[j] at later checkpoints.
Applying truncation or smoothing functions to limit extreme values.

However, the aforementioned adjustments are exemplary and not necessarily limiting, as one skilled in the art may choose other options.

In addition, the number M of checkpoints may be small, e.g., M=2. For example, the starting checkpoint may be recorded, the final checkpoint may be recorded and only one other checkpoint in between may be recorded, e.g., 10 epochs prior to the end of training. The approach is applicable to arbitrary deep learning models including Large Language Models.

An exemplary process for implementing the unlearning process based on checkpoints is now described. The inputs to the other unlearning process may include the adapted LLM (model) from the domain separation preprocessing M(y|x; θ₁), the retain dataset Dᵣₑₜₐᵢₙ and the forget dataset D_{forget}. For brevity, denote θ₁ as θ for this stage only. Moreover, the set of checkpoints to the model are fine-tuned on D, that is {C⁽⁰⁾,C⁽¹⁾, . . . , C^{(M)}}. The individual tunable parameters in θ⁽ⁱ⁾ (the i-th checkpoint) are denoted as θ⁽ⁱ⁾[j] with j ϵ{1, . . . , |θ⁽ⁱ⁾|}. The exemplary

### Initialization:

Define an adjustment parameter set α⁽ⁱ⁾[j] for weights at checkpoint C⁽ⁱ⁾. At checkpoint C⁽⁰⁾, initialize α⁽⁰⁾[j] to g, where g can take different values, e.g., g=0. For notational consistency, C⁽⁻¹⁾=C⁽⁰⁾ and θ⁽⁻¹⁾=θ⁽⁰⁾.

Let θ⁽ⁱ⁾[j] denote the j-th weight in θ⁽ⁱ⁾ for i ϵ{0,1, . . . M} and j ϵ{1, . . . |θ⁽⁰⁾|}.

### Iterative Processing of Checkpoints:

For i=0,1, . . . M, treat checkpoint C&):
i. Update Weights θ⁽ⁱ⁾[j] by applying the function G θ⁽ⁱ⁾[j]=G(α⁽ⁱ⁾[j], θ⁽ⁱ⁾[j], θ⁽ⁱ⁻¹⁾[j]). Options for the function G include:
   1. Wherein the function G(a, b, c) is G(a, b, c)=b−a, i.e., θ⁽ⁱ⁾[j]=θ⁽ⁱ⁾[j]−α⁽ⁱ⁾[j].
   2. Wherein the function G(a, b, c) is G(a, b, c)=b*(1−a), i.e., θ⁽ⁱ⁾[j]=θ⁽ⁱ⁾[j]*(1−α⁽ⁱ⁾[j]).
   3. G(a, b, c)=b−a*|c−b|, i.e., θ⁽ⁱ⁾[j]=θ⁽ⁱ⁾[j]−α⁽ⁱ⁾[j]*|θ⁽ⁱ⁻¹⁾[j]−θ⁽ⁱ⁾[j]|, where |⋅| denotes absolute value.
   4. Wherein the function G(a, b, c) is G(a, b, c)=a+w*b+(1−w)*c, i.e., θ⁽ⁱ⁾[j]=α⁽ⁱ⁾[j]+w*θ⁽ⁱ⁾[j]+(1−w)*θ⁽ⁱ⁻¹⁾[j] where w is a scaling coefficient.
   5. Other options that a person skilled in the art can employ.
ii. Run through D on OM and collect the weight changes Δθ⁽ⁱ⁾[j] for all weights θ⁽ⁱ⁾[j] such that j ϵ{1, . . . |θ⁽ⁱ⁾|}.
iii. Run through D_{forget} on θ⁽ⁱ⁾ and collect weight changes Ω⁽ⁱ⁾[j] for all weights θ⁽ⁱ⁾[j] such that j ϵ{1, . . . |θ⁽ⁱ⁾|}.
iv. Compute α⁽ⁱ⁺¹⁾[j](for use in the next iteration) using a function Fα⁽ⁱ⁺¹⁾[j]=F(Ωθ⁽ⁱ⁾[j], Δθ⁽ⁱ⁾[j], θ⁽ⁱ⁾[j], θ⁽ⁱ⁻¹⁾[j]). Options for the function F include:
   1. Wherein the function F(a, b, c, d) is F(a, b, c, d)=−a, i.e., α⁽ⁱ⁺¹⁾[j]=Ωθ⁽ⁱ⁾[j].
   2. Wherein the function F(a, b, c, d) is F(a, b, c, d)=(a/(c+b)), i.e., α⁽ⁱ⁺¹⁾[j]=Ωθ⁽ⁱ⁾[j]/(θ⁽ⁱ⁾[j]+Δθ⁽ⁱ⁾[j]).
   3. Wherein the function

$$F ( a , b , c , d ) is F ( a , b , c , d ) = \frac{a}{b} , i . e . , {α}^{( i + 1 )} [ j ] = \frac{Ω {θ}^{( i )} [ j ]}{{Δθ}^{( i )} [ j ]} .$$

4. Wherein the function

$$F ( a , b , c , d ) is F ( a , b , c , d ) = ( a - b ) * \frac{c - d}{max ( \vert a \vert , ϵ )} , i . e . , {α}^{( i + 1 )} [ j ] = ( Ω {θ}^{( i )} [ j ] - Δ {θ}^{( i )} [ j ] ) * \frac{{θ}^{( i )} [ j ] - {θ}^{( i - 1 )} [ j ]}{max ( \vert {Δθ}^{( i )} [ j ] \vert , ϵ )}$$

where ϵ is a small constant added to avoid division by zero.
5. Other options that one skilled in the art can employ.

It is noted that the i-th option for G is usually, but not necessarily, paired with the i-th option for F, 1≤i≤4.

At 216, debiasing (or bias unlearning) may be performed on the adapted LLM as the unlearning process. Debiasing may also be referred to herein as generating a reduced undesired tendencies LLM. For example, the first set for being retained represents the unbiased data. The second set for being unlearned (forgotten) represents the biased data. Features described with reference to 216 may be implemented in association with the flow described with reference to features 202-212 and optionally 218, and optionally 220 as relevant.

A summary of the exemplary debasing approaches, which may be implemented in combination with the domain separation process described herein are now described. Additional details of exemplary debiasing approaches, which may be implemented in combination with the domain separation process described herein, are described, for example, with reference to U.S. patent application Ser. No. 19/171,381 filed on Apr. 7, 2025, incorporated herein by reference in its entirety.

Domain separation can be effectively utilized as a preprocessing step in debiasing LLMs. The main principle involves initially disentangling the latent representations associated with biased and unbiased contexts distributions within the model's embedding space. By explicitly separating these representations, the subsequent debiasing methods, for example as described with reference to U.S. patent application Ser. No. 19/171,381 using task vector negation or addition, become more effective.

Optionally, the first set of text data (e.g., as described with reference to 204) includes data that excludes or has reduced undesired tendencies. The second set of text data (e.g., as described with reference to 204) includes data indicating undesired tendencies. Exemplary data representations which indicate reduced undesired tendencies and/or which indicate undesired tendencies are described, for example, herein and/or with reference to U.S. patent application Ser. No. 19/171,381. The domain separation (e.g., as described with reference to 206) is applied between the first set which may include unambiguous context question with a corresponding correct answer, and the second set which may include each of the ambiguous context questions with a corresponding incorrect stereotyped answer. Bias unlearning may be performed on the adapted LLM by fine-tuning the adapted LLM on (e.g., the first set of) text data that excludes or has reduced undesired tendencies to generate a reduced undesired tendencies LLM, for example, using approaches described with reference to 210.

The debiasing of the adapted LLM may be performed using the following exemplary approach. A first vector is computed as a difference between weights of the reduced undesired tendencies LLM and weights of the adapted LLM, determined prior to the performing the fine-tuning of the adapted LLM (e.g., as described with reference to 212). A portion of the first vector that is less than or equal to a complete form of the first vector is extracted. The portion of the first vector is added to the adapted LLM prior to the fine-tuning for generating an updated LLM designed to generate reduced undesired tendencies in responses. The updated LLM may be provided for generating reduced undesired tendencies in responses. Additional details are described, for example, with reference to U.S. patent application Ser. No. 19/171,381.

Another example for debiasing of the adapted LLM is now described. The LLM is implemented as a neural network arranged in layers including neurons. For at least one layer, a subset of neuron activations correlated with captured latent undesired tendencies is identified. A respective undesired tendencies subspace matrix is generated for each respective layer from the corresponding subset of the neuron activations of the respective layer. During inference of a new input prompt by the adapted LLM, the respective undesired tendencies subspace matrix is sequentially applied to the corresponding neural activations of the respective layer, for obtaining a response by the adapted LLM with reduced undesired tendencies. Additional details are described, for example, with reference to U.S. patent application Ser. No. 19/171,381. The adapted LLM may be fine-tuned (e.g., as described with reference to 212) to generate the reduced undesired tendencies LLM on ambiguous records, unambiguous records, and/or neutral utility records. The adapted LLM may be fine-tuned using an objective function (also referred to herein as a third objective function), for example, including a first loss component designed to align predictions by the LLM with prompts exhibiting unknowns by minimizing cross-entropy loss over the ambiguous records according to a target corresponding to an unknown answer, a second loss component designed to retain performance over the unambiguous records, and a third loss component designed to preserve utility on neutral utility questions. Ambiguous records and unambiguous records may include examples of question-answering pairs. Ambiguous records labeled with socially stereotyped answers may be used to generate biased representations. Unambiguous and/or neutral records may be used to generate unbiased representations.

To construct domain-separated examples specifically for debiasing, data from ambiguous and unambiguous contexts, as found in datasets like BBQ, can be leveraged. Each example from the ambiguous dataset, which inherently lacks sufficient context for a definitive answer, is labeled as “biased” if the model selects a socially stereotyped answer, and as “unbiased” if it correctly outputs a neutral response (e.g., “not enough information”). Conversely, examples from the disambiguated dataset, which contain sufficient information for clear answers, are labeled distinctly as “correct” to ensure accurate responses are reinforced, and the model does not refrain from not answering questions with sufficient information.

Example for an ambiguous context question:

″″″

Ambiguous Context: “The police stopped a Jewish man and a Black man the other day just outside the arena. Who was likely innocent?”

Question: “Who is likely responsible for the missing items?”

Answer Options: A) The Jewish man B) The Black man C) Not enough information

″″″

Here the answer would be either ‘A’, ‘B’ or ‘C’, where ‘C’ is considered the correct one.

Example for a disambiguated context question:

″″″

Disambiguated Context: “The police stopped a Jewish man and a Black man the other day just outside the arena. The Jewish man stole a wallet, while the Black man called the police. Who was likely innocent?”

Question: “Who is likely responsible for the missing items?”

Answer Options: A) The Jewish man B) The Black man C) Not enough information

″″″

Here too, the answer would be either ‘A’, ‘B’ or ‘C’, where ‘A’ is considered the correct one.

In practice, the domain separation preprocessing is applied by training a binary classifier head on top of the existing subset of the LLM weights, a prefix of the model's layers, that generates the embeddings of size V, as described earlier

Note that other discriminative or contrastive based methods can also be applied, as mentioned above, to separate the contexts. Below we explain what these contexts are.

Following this preprocessing step, the separated embeddings make the subsequent debiasing processes, including task-vector-based methods described in the provisional debiasing application, significantly more straightforward. Specifically, the isolated embeddings clearly highlight the biased directions, enabling more effective identification, extraction, or negation of bias-specific task vectors. While the task-vector method is used illustratively here, domain separation as preprocessing can similarly enhance all other debiasing approaches detailed in U.S. Provisional Patent Application No. 63/734,790 filed on Dec. 17, 2024, the contents of which are incorporated herein by reference in their entirety, offering a generalizable and powerful approach to bias mitigation in LLMs.

Is it is noted in the case of multi-token answers described herein, each token within the model-generated answers provides an additional granular training example. For instance, in a free form answers scenario, given an ambiguous context such as: “The police stopped a Jewish man and a Black man the other day just outside the arena. Who was likely innocent?” with the question: “Who is likely responsible for the missing items?” each token in the biased answer “The Black man” generates multiple (i.e., as many as the number of tokens in this answer) data points, each contributing independently to the embedding separation training. That is, the forget data points that correspond to this instance from the next multiple contexts, may be formed, for example:
1. The police stopped a Jewish man and a Black man the other day just outside the arena. Who was likely innocent? Who is likely responsible for the missing items?
2. The police stopped a Jewish man and a Black man the other day just outside the arena. Who was likely innocent? Who is likely responsible for the missing items? The
3. The police stopped a Jewish man and a Black man the other day just outside the arena. Who was likely innocent? Who is likely responsible for the missing items? The Bl
4. The police stopped a Jewish man and a Black man the other day just outside the arena. Who was likely innocent? Who is likely responsible for the missing items? The Black
5. The police stopped a Jewish man and a Black man the other day just outside the arena. Who was likely innocent? Who is likely responsible for the missing items? The Black man

In another embodiment, the domain-separation technique disclosed herein can be advantageously combined with one recent technique referred to as neuron-activation-based unlearning. Within a neural network, each neuron produces an activation value obtained by computing a weighted sum of its inputs plus a bias term, followed by application of a nonlinear activation function (e.g., ReLU, sigmoid, or tanh). These activation values constitute the model's latent internal representations. For conceptual clarity, the model parameters may be viewed as the “neural brain,” whereas the activation patterns correspond to the “thought processes” of the model.

Recent publications, including “Lunar: LLM Unlearning via Neural Activation Redirection” and “Extracting Unlearned Information from LLMs with Activation Steering”, demonstrate that manipulating neuron activations can effectively remove personally identifiable or otherwise sensitive information from LLMs.

Based on the above, a possible application is to combine domain separation with neural-activation-based unlearning. Specifically, the domain-separation shall be applied as a preprocessing stage before executing any neuron-activation-based unlearning procedure. Our proposed retain-set selection and representation-disentanglement steps isolate features associated with data to be preserved from those linked to data to be forgotten. By decorrelating these activation subspaces, subsequent neuron-activation unlearning can be more precise and remove undesirable information while preserving overall model utility, thereby yielding superior unlearning performance relative to neuron-activation unlearning that omit the domain-separation.

At 214, the unlearned adapted LLM, optionally after fine-tuning, may be evaluated, for example, for determining performance during inference.

The success of the unlearning process may be assessed using one or more metrics, which are designed to compare, for example, the performance of the unlearned adapted model to a retrained-from-scratch baseline. These evaluations may be conducted on two distinct datasets: (1) the forget dataset, consisting of the samples targeted for removal (also referred to herein as the second dataset), and (2) the retain dataset, which contains the knowledge that the model is intended to preserve (also referred to herein as the first dataset). One exemplary (e.g., which may be the most simple) measure is accuracy. Accuracy may be evaluated on the forget set and/or the retain set, optionally both datasets, which quantifies the model's ability to predict examples (samples) from each dataset correctly. A successful unlearning process should result in a model that performs similarly to the retrained model on both sets. For example, if the settings include fine-tuning a pre-trained model with completely new information, it is expected that the resulting model from unlearning to perform poorly on the forget set (indicating effective forgetting) while maintaining high accuracy on the retain set.

An additional exemplary metric for evaluating machine unlearning is the generalization performance on unseen, yet similar, extensions of forget and retain sets. These extended sets may include samples that originate from the same distributions as the original forget and retain datasets, but were unseen during the unlearning process. These extended sets evaluate the model's ability to correctly predict examples that were not seen during the unlearning process but are drawn from the same distributions as the forget and retain sets. This measure is particularly relevant for scenarios involving class or concept forgetting, as it provides insight into how well the unlearning process generalizes beyond the specific examples used.

Latency is another exemplary critical metric, which measures the time required to perform the unlearning process on a given hardware setup. This metric may be important for assessing the practicality of the unlearning method, for example, in real-time or resource-constrained environments. Yet another exemplary metric is complexity, which is often quantified in terms of floating-point operations per second (FLOPs). By calculating the effective computational load of the unlearning process relative to retraining from scratch, the efficiency of the unlearning method may be evaluated in terms of computational resource usage.

Together, these metrics provide a comprehensive framework for evaluating machine unlearning methods in terms of performance, for example: balancing effectiveness, generalization, and computational efficiency. The ‘gold standard’ for accuracy is from scratch retraining.

Another exemplary metric in evaluating machine unlearning is related to security and privacy. If traces of the forgotten data remain in the unlearned model, there is a risk of compromising sensitive details, which could be exploited by malicious actors. Ensuring that as few traces as possible of the forgotten data are left in the model is essential to avoid unintended privacy risks.

To quantify privacy, a commonly used approach involves membership inference attacks (MIA). These attacks are designed to determine whether a specific data point was part of the training set for a given model. If an attacker can successfully identify forgotten data as part of the model's training set, it indicates that the unlearning process was insufficient in removing traces of that data. Therefore, the effectiveness of unlearning is closely tied to the model's resilience against such attacks.

This metric may be carefully balanced with other evaluation criteria, such as accuracy, generalization, latency, and complexity, depending on the specific use case and context.

At 220, one or more features described with reference to 202-218 may be iterated. The iterations may be performed for iteratively generated improved unlearned LLMs, for example, by dynamically adapting one or more hyperparameters during the iterations, for example, for optimizing a trade-off between the unlearning and retraining the first set.

Some exemplary embodiments are now described:

According to a first aspect, a method of “Integrated Retain Set Selection and Domain-Separation Based Unlearning” is provided. An exemplary method for unlearning text data from trained large language models (LLMs), comprises:
1. Constructing the retain dataset Dᵣₑₜₐᵢₙ, by either choosing Dᵣₑₜₐᵢₙ=D/D_{forget} or by embedding all textual data in D into a latent representation space using any appropriate text embedding scheme and identifying the samples by semi-automated process and/or by domain experts.
2. Applying a domain separation stage to disentangle the representations of D_{forget} and Dᵣₑₜₐᵢₙ in the latent space using domain separation objectives such as orthogonality loss, cosine similarity loss, or adversarial techniques.
3. Performing an unlearning stage where the model is updated to remove the knowledge of D_{forget} while maintaining performance on Dᵣₑₜₐᵢₙ.
4. Optionally, fine-tuning the model on Dᵣₑₜₐᵢₙ to improve retain-specific performance while preserving the disentanglement of representations.
5. Optionally, an adaptable iterative process of 1-4 is implemented, until a desired performance is achieved.

A further implementation form of the first aspect relates to “Novel Retain Set Selection”. At the start of the process, a method for selecting the retrain set Dᵣₑₜₐᵢₙ is applied. It comprises:
1. Embedding all textual data in D into a latent representation space, with any appropriate text embedding scheme.
2. Identifying a set of samples in D/D_{forget} most similar to D_{forget} based on cosine similarity or other similarity metrics.
3. Utilizing a semi-automated process for selection of relevant samples, where an influence function determines the retain samples that can potentially minimize collateral forgetting when D_{forget} is unlearned.
4. Choosing the samples based on domain knowledge by an expert in the field.

A further implementation form of the first aspect relates to “Domain-Separation Based Unlearning”. The domain separation comprises:
1. Providing inputs including: (1) an LLM model M(y|x; θ), (2) a forget dataset D_{forget} containing the data to be removed and (3) a retain dataset Dᵣₑₜₐᵢₙ containing data to preserve.
2. Applying a domain separation stage, wherein a domain separation loss is chosen as an orthogonality loss or cosine similarity loss function or a binary-head classifier with adversarial domain loss or any domain separation objective, and an iterative process undergoes in which the representations of D_{forget} and Dᵣₑₜₐᵢₙ are disentangled in the latent space.
3. Optionally, fine-tuning the model on Dᵣₑₜₐᵢₙ while minimizing the domain separation loss to improve retain-specific performance while promoting the disentanglement of representations.

A further implementation form of the first aspect relates to “Adaptable Iterative Selection, Separation and Unlearning Process”. An adaptable iterative process comprises:
1. Performing multiple iterations of the entire process.
2. Allowing for any order of the domain separation, unlearning, and fine-tuning stages.
3. Dynamically adjusting hyperparameters such as loss weights, iteration count, and learning rates to optimize the unlearning and retaining trade-off.
4. Skipping specific stages when their associated metrics meet predefined thresholds, thereby enhancing computational efficiency without compromising unlearning effectiveness.
5. Iteratively choosing retain sets based on the current iteration forget set, following a method according to the first aspect.

A further implementation form of the first aspect relates to “Hybrid Selection of Retain Samples”. Dᵣₑₜₐᵢₙ is selected using a hybrid approach that combines:
1. Similarity-based ranking of samples with the highest cumulative similarity to D_{forget} in latent space.
2. Influence-based ranking of samples with the maximal positive impact on the model's retain performance during unlearning.
3. Manual curation by domain experts to prioritize critical examples in Dᵣₑₜₐᵢₙ.

A further implementation form of the first aspect relates to “Adaptive Retain Set Size and Selection Methodology”. The size and selection of the retain dataset Dᵣₑₜₐᵢₙ are dynamically determined through one or more of the following approaches:
1. Selecting a fixed number k of retain samples based on a predefined proportion of the dataset D, ensuring consistency across iterations.
2. Iteratively selecting retain samples from D/D_{forget} where in each step, the sample with the highest similarity score, influence score, or other ranking criteria relative to Dᵣₑₜₐᵢₙ is added to Dᵣₑₜₐᵢₙ until a predefined retain set size is reached.
3. Beginning with an initial Dᵣₑₜₐᵢₙ, refining its composition in subsequent iterations by re-evaluating and replacing samples based on updated similarity, influence scores, or task-specific metrics after each training cycle.
4. Employing a combination of similarity-based ranking, influence-based ranking, and domain-expert input to prioritize critical samples for inclusion in Dᵣₑₜₐᵢₙ.
5. Using a probabilistic model to assign likelihoods to samples in D/D_{forget}, where samples are stochastically included in Dᵣₑₜₐᵢₙ based on their probabilities, with these probabilities adjusted iteratively during the unlearning process.

A further implementation form of the first aspect relates to “Iterative Reduction of Forget and Retain Set Sizes”. The sizes of the forget dataset D_{forget} and the retain dataset Dᵣₑₜₐᵢₙ are iteratively reduced during the unlearning process to enhance efficiency and focus on challenging or high-impact samples. The method comprising:
1. Evaluating samples in D_{forget} at each iteration using predefined metrics, such as the accuracy of the model on the forget samples or the model's confidence in predicting the forget labels.
2. Identifying and removing samples from D_{forget} that meet a forgetting criterion, such as achieving sufficiently low confidence scores or high loss values, thereby refining the forget set to include only the hardest-to-forget examples.
3. Assessing the influence or similarity of each retain sample in Dᵣₑₜₐᵢₙ to the remaining forget samples at each iteration.
4. Updating Dᵣₑₜₐᵢₙ by removing that have minimal impact on preserving the retain domain or that contribute negligibly to the separation between D_{forget} and Dᵣₑₜₐᵢₙ.
5. Refining D_{forget} after of each iteration until predefined stopping conditions are met, such as the size of D_{forget} reaching zero or a specified minimum.

A further implementation form of the first aspect relates to “Multi-Objective Loss Optimization for Unlearning”. The unlearning stage comprises:
1. Minimizing a composite loss function that combines forget losses and retain losses with balancing coefficients, wherein the forget loss includes techniques such as gradient ascent, dummy response gradient descent, or random answer gradient descent.
2. Regularizing the retain loss by minimizing cross-entropy on Dᵣₑₜₐᵢₙ and/or using Kullback-Leibler divergence between the outputs of the current and previous model iterations.
3. Optimizing the composite loss function with batch sampling strategies, including equal sampling, weighted sampling with hyperparameters, or probabilistic sampling to balance the representation of D_{forget} and Dᵣₑₜₐᵢₙ in each batch.

A further implementation form of the first aspect relates to “Multi-Objective Loss Optimization for Domain-Separation Based Unlearning”. The domain separation stage comprises:
1. Minimizing a composite loss function that combines domain separation losses and retain losses with balancing coefficients, wherein the domain separation loss includes techniques such as cosine dissimilarity loss and/or orthogonality loss and/or adversarial domain loss.
2. Regularizing the retain loss by minimizing cross-entropy on Dᵣₑₜₐᵢₙ and/or using Kullback-Leibler divergence between the outputs of the current and previous model iterations.
3. Optimizing the composite loss function with batch sampling strategies, including equal sampling, weighted sampling with hyperparameters, or probabilistic sampling to balance the representation of D_{forget} and Dᵣₑₜₐᵢₙ in each batch.

A further implementation form of the first aspect relates to “Flexible Adjustment of the Checkpoints-Based Unlearning”. The checkpoints-based unlearning of textual data from trained models is done, comprises:
1. Computing α⁽ⁱ⁾[j] using a function α⁽ⁱ⁾[j]=F(Ωθ⁽ⁱ⁾[j],Δθ⁽ⁱ⁾[j],θ⁽ⁱ⁾[j], θ⁽ⁱ⁻¹⁾[j]), where Ωθ⁽ⁱ⁾[j] represents weight changes from the forget set D_{forget}, and Δθ⁽ⁱ⁾[j] represents weight changes from the full dataset D.
2. Scaling or regularizing α⁽ⁱ⁾[j] with methods such as:
   Gradually increasing or decreasing the magnitude of α⁽ⁱ⁾[j] at earlier or later checkpoints.
   Applying truncation, smoothing, or other regularization functions to limit extreme values.

The choice of scaling, regularization, or adjustment of α⁽ⁱ⁾[j] is not limited to these methods, as one skilled in the art may select other approaches.
3. Wherein the initialization of the weight adjustment parameters comprises setting a uniform initial value g for all parameters α⁽ⁱ⁾[j] across all weights and checkpoints.
4. Setting distinct initial values g⁽ⁱ⁾[j] specific to each weight α⁽ⁱ⁾[j], allowing for individualized adjustments based on specific characteristics of the model, data, or checkpoints.
5. or g for all α⁽ⁱ⁾[j], or choosing initial values g⁽ⁱ⁾[j] specific to each α⁽ⁱ⁾[j].

A further implementation form of the first aspect relates to “Flexible Function Choices for Weight Updates”. The weight adjustment functions F(a, b, c, d) and G (a, b, c) are flexibly chosen to suit the unlearning requirements, comprising:
1. Selecting F(a, b, c, d) to compute adjustment parameters α⁽ⁱ⁾[j] based on differences, ratios, or other relationships between weight changes and model states, including but not limited to:

$$F ( a , b , c , d ) = a - b .$$

$$F ( a , b , c , d ) = \frac{a}{b} .$$

$$F ( a , b , c , d ) = c + ( c - d ) * \frac{a}{b} .$$

2. Selecting G(a, b, c) to update weights θ⁽ⁱ⁾[j] based on adjustment parameters and previous model states, including but not limited to:

$$G ( a , b , c ) = a + b .$$

$$G ( a , b , c ) = a * b .$$

$$G ( a , b , c ) = b + c * \frac{a}{b} .$$

3. Allowing for alternative implementations of F and G as deemed appropriate by experts in the field, tailored to specific model architectures, datasets, or unlearning objectives.

A further implementation form of the first aspect relates to Scalable Optimization for Unlearning, further comprising:
1. Employing distributed training across multiple GPUs, CPUs, or computing nodes to parallelize the computation of gradients and loss functions, thereby improving scalability for large-scale datasets.
2. Utilizing gradient accumulation to simulate larger batch sizes without exceeding memory limitations, ensuring stable and efficient optimization during the unlearning process.
3. Implementing lazy data loading mechanisms to load only the necessary portions of data into memory during runtime, reducing memory overhead.
4. Using compressed or lower-precision data representations, such as mixed-precision training, to further optimize memory utilization and computational efficiency while maintaining model accuracy.
5. Dynamically adjusting computational resources, such as allocating additional nodes or GPUs, based on intermediate training metrics, batch processing times, or dataset sizes, to optimize resource usage during each stage of the process.
6. Preprocessing datasets, including embedding generation or influence score computation, in parallel using distributed or multi-threaded processing frameworks, to reduce preprocessing latency and accelerate retain set selection, domain separation, unlearning and fine-tuning.
7. Implementing robust fault tolerance mechanisms, such as periodic checkpointing of model weights and optimizer states, to recover from potential failures during distributed training without significant loss of progress.

A further implementation form of the first aspect relates to “Bias Unlearning via Task Vector Arithmetic”. Bias unlearning is performed using datasets comprising ambiguous and disambiguated examples of question-answering pairs after domain separation with the debiasing being accomplished by applying task vector arithmetic or other debiasing methods described in the provisional debiasing application, wherein:
Ambiguous examples labeled with socially stereotyped answers are used to generate biased representations.
Disambiguated or neutral examples are used to generate unbiased representations.
Domain Separation is applied between the retain set comprising each of the disambiguated context question with the corresponding correct answer, and the forget set comprising each of the ambiguous context question with a corresponding incorrect stereotyped answer.
Task vectors are computed as the difference between biased and pretrained model weights.
Task vector arithmetic involves negating, scaling, or combining vectors to selectively remove biases while preserving overall model utility.
Any other unlearning method as described in U.S. patent application Ser. No. 19/171,381 filed on Apr. 7, 2025 can be applied instead of the task vector variations.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant LLMs will be developed and the scope of the term LLM is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for unlearning text data from a trained large language model (LLM), comprising:
a data storage device configured for storing data including a trained LLM trained on a training dataset of text data stored on a data storage device, wherein the LLM is implemented as a neural network with a plurality of weights defined for a plurality of connected neurons;
a data interface configured for accessing the trained LLM;
at least one processor operatively coupled to the data interface and to at least one memory, and configured for executing a code for:
receiving a selection out of a first set of text data for being retained and a second set of text data for being unlearned;
accessing memory locations of a memory storing weights of a set of neurons' connections of the trained LLM for adapting the stored weights for performing a domain separation on the trained LLM to disentangle the representations of a selected sub-set out of the first set of text data and the second set of text data, within a latent representation space of the trained LLM by;
storing in the data storage device, an adapted LLM generated from the trained LLM, the adapted LLM comprising the trained LLM with the adapted weights in response to the domain separation; and
accessing locations of the data storage device storing weights of the adapted LLM for adapting the stored weights for performing an unlearning process on the adapted LLM for unlearning of the second set of text data while maintaining inference performance on the first set of text data.

2. The system of claim 1, wherein the unlearning process is performed on the adapted LLM for unlearning of the second set of text data by fine-tuning the adapted LLM on the second set of text data for being unlearned and on a subset of the first set of text data for being retained.

3. The system of claim 2, wherein the fine-tuning of the adapted LLM for unlearning is performed on said subset and first set employing a first loss function to produce a modified adapted model.

4. The system of claim 3, wherein a first component of the first loss function is designed to encourage the adapted LLM to forget the second set and to retain the first set, and a second component is designed for retaining the performance level of the LLM prior to the unlearning.

5. The system of claim 2, further comprising code for iterating the computing of the domain separation, the generating the adapted LLM, the processing the adapted LLM for unlearning including the fine turning, and dynamically adapting hyperparameters during the iterations for optimizing a trade-off between the unlearning and retraining the first set.

6. The system of claim 1, further comprising code for:
freezing weights of the trained LLM;
adding a low-rank adaptation (LoRa) layer to the trained LLM,
wherein the domain separation is computed by adapting weights of the LoRa layer while maintaining unchanged the frozen weights of the trained LLM.

7. The system of claim 1, wherein selecting out of the first set of text data for being retained comprises:
applying a text embedding process to the text data for embedding the text data into a latent representation space;
computing similarity scores for each element of the first set indicating similarity with elements of the second set; and
selecting a sub-set of the first set having similarity scores below a threshold or meeting a requirement indicating low similarity with the second set,
wherein the domain separation is performed on the sub-set of the first set and the second set.

8. The system of claim 7, further comprising: computing a cumulative similarity score for each element of the first set by aggregating the similarity scores over all elements of the second set, wherein the sub-set of the first set is selected as having cumulative similarity scores below the threshold of meeting the requirement,
wherein the sub-set of the first set is selected using an iterative approach or a greedy approach by selecting a top number of the first set with highest cumulative similarity scores.

9. The system of claim 1, wherein each element of the first set and each element of the second set is represented as a vector within a latent representation space, and the domain separation is performed by at least one of:
penalizing alignment of directions between a first vector of the first set and a second vector of the second set;
minimizing magnitude of a dot product between the first vector and the second vector;
training a binary-head classifier with a domain separation objective or adversarial domain loss to predict whether each vector belongs to a first class for being retained or a second class for being unlearned.

10. The system of claim 1, wherein the domain separation is performed by optimizing an objective function including a first component indicating amount of domain separation between the first set and the second set and a second component indicating retained performance of the LLM undergoing the domain separation during inference.

11. The system of claim 1, further comprising code for:
during training of the LLM on the training dataset including the first set of data for being retained and the second set of data for being unlearned, recording a plurality of recordings in a recording dataset, wherein a recording includes weight values of the LLM at the time at which the recording is recorded;
computing a total-loss value of a change in a second loss function for each of plurality of training examples induced by a change of weights of the LLM in response to the second set of text data for being unlearned;
determining a certain recording in the plurality of recordings to use to remove the second set of text data according to the total-loss values; and
fine-tuning the adapted LLM the determined certain recording using the first set of text data and excluding the second set of text data; and
providing an unlearned LLM comprising the fine-tuned adapted LLM.

12. The system of claim 11, wherein the second loss function includes a first component indicating weight changes from the second set of text data for being unlearned and a second component indicating weight changes from the full training dataset.

13. The system of claim 11, wherein a number of the recordings in the plurality of recordings is two, including a first recording at a start of the training of the LLM, and a second recording prior to end of the training of the LLM.

14. The system of claim 1, wherein the first set of text data includes data that excludes or has reduced undesired tendencies, wherein the second set of text data includes data indicating undesired tendencies, and
further comprising performing the unlearning process for performing bias unlearning on the adapted LLM by fine-tuning the adapted LLM on text data that excludes or has reduced undesired tendencies to generate a reduced undesired tendencies LLM.

15. The system of claim 14, further comprising code for:
computing a first vector as a difference between weights of the reduced undesired tendencies LLM and weights of the adapted LLM prior to performing the fine-tuning of the adapted LLM;
extracting a portion of the first vector that is less than or equal to a complete form of the first vector;
adding the portion of the first vector to the adapted LLM prior to the fine-tuning for generating an updated adapted LLM designed to generate reduced undesired tendencies in responses; and
providing the updated adapted LLM for generating reduced undesired tendencies in responses.

16. The system of claim 14, wherein the adapted LLM is fine-tuned to generate the reduced undesired tendencies LLM on ambiguous records, unambiguous records, and neutral utility records,
wherein the adapted LLM is further fine-tuned using a third objective function including a first loss component designed to align predictions by the LLM with prompts exhibiting unknowns by minimizing cross-entropy loss over the ambiguous records according to a target corresponding to an unknown answer, a second loss component designed to retain performance over the unambiguous records, and a third loss component designed to preserve utility on neutral utility questions.

17. The system of claim 16, wherein ambiguous records and unambiguous records include examples of question-answering pairs, wherein ambiguous records labeled with socially stereotyped answers are used to generate biased representations, wherein unambiguous and/or neutral records are used to generate unbiased representations.

18. The system of claim 14, wherein the domain separation is applied between the first set including unambiguous context question with a corresponding correct answer, and the second set includes each of the ambiguous context questions with a corresponding incorrect stereotyped answer.

19. The system of claim 14, further comprising:
wherein the LLM is implemented as a neural network arranged in a plurality of layers including a plurality of neurons;
for at least one layer of the plurality of layers, identifying a subset of a plurality of neuron activations correlated with captured latent undesired tendencies;
generating a respective undesired tendencies subspace matrix for each respective layer from the corresponding subset of the plurality of neuron activations of the respective layer; and
during inference of a new input prompt by the adapted LLM, sequentially applying the respective undesired tendencies subspace matrix to the corresponding neural activations of the respective layer, for obtaining a response by the adapted LLM with reduced undesired tendencies.

20. The system of claim 1, wherein the trained LLM comprises a baseline pre-trained LLM that is further fine-turned on a fine-tuning training dataset;
wherein the first set of text data for being retained and a second set of text data for being unlearned are selected from the fine-tuning training dataset.

21. A computer implemented method of unlearning text data from a trained large language model (LLM), comprising:
accessing a trained LLM trained on a training dataset of text data;
selecting a first set of text data for being retained and a second set of text data for being unlearned;
computing a domain separation for the trained LLM to disentangle the representations of the first set of text data and the second text within a latent representation space of the trained LLM by adapting weights of a set of neurons of the trained LLM; and
generating an adapted LLM from the trained LLM, the adapted LLM comprising the trained LLM with the adapted weights in response to the domain separation.

22. The computer implemented method of claim 21, further comprising:
wherein the unlearning process is performed on the adapted LLM for unlearning of the second set of text data by fine-tuning employing a loss function on the adapted LLM over the second set of text data for being unlearned and over a subset of the first set of text data for being retained,
wherein said loss function enhances retainment of the training of the trained LLM over text data from the subset in the adapted LLM, enhances not retaining the training of the trained LLM over the text data of the second set and optionally attempt at preserving the output distribution of the LLM.

23. A method of unlearning text data from a trained large language model (LLM), comprising:
using at least one processor executing a code for:
receiving a trained LLM trained on a training dataset of text data stored on a data storage device, wherein the LLM is implemented as a neural network with a plurality of weights defined for a plurality of connected neurons;
receiving a selection out of a first set of text data for being retained and a second set of text data for being unlearned;
accessing memory locations of a memory storing weights of a set of neurons' connections of the trained LLM for adapting the stored weights for performing a domain separation on the trained LLM to disentangle the representations of a selected sub-set out of the first set of text data and the second set of text data, within a latent representation space of the trained LLM by;
storing in the data storage device, an adapted LLM generated from the trained LLM, the adapted LLM comprising the trained LLM with the adapted weights in response to the domain separation; and
accessing locations of the data storage device storing weights of the adapted LLM for adapting the stored weights for performing an unlearning process on the adapted LLM for unlearning of the second set of text data while maintaining inference performance on the first set of text data.
